(19) United States
(12) Patent Application Publication
(10) Pub. No.: US 2021/0114370 A1
(43) Pub. Date: Apr. 22, 2021

(54) INFORMATION PROCESSING APPARATUS, LEARNING APPARATUS, AND CONTROL METHOD OF INFORMATION PROCESSING APPARATUS

(71) Applicant: SEIKO EPSON CORPORATION, Tokyo (JP)

(72) Inventor: Nobutada MIZUSAWA, Sapporo-shi (JP)

(21) Appl. No.: 17/070,265

(22) Filed: Oct. 14, 2020

(30) Foreign Application Priority Data
Oct. 16, 2019 (JP) 2019-189109

(51) Int. Cl. B41J 2/045; G06N 20/00

(52) U.S. Cl. CPC B41J 2/04563; G06N 20/00; B41J 2/04505; B41J 2/0454; B41J 2/0458

(57) ABSTRACT

Provided is a printer including: a printer storage section that stores a learned model that was trained by machine learning based on a data set in which work gap information indicating a work gap which is a distance between a printing medium and a nozzle surface of a print head, and landing position information related to a deviation of a landing position of ink discharged from the print head are associated; and a processing section that outputs a landing position deviation amount from the learned model by acquiring a printing condition, and inputting the work gap information included in the acquired printing condition to the learned model stored in the printer storage section.

The present application is based on, and claims priority from JP Application Serial Number 2019-189109, filed Oct. 16, 2019, the disclosure of which is hereby incorporated by reference here in its entirety.

### BACKGROUND

### 1. Technical Field

The present disclosure relates to an information processing apparatus, a learning apparatus, and a control method of an information processing apparatus.

### 2. Related Art

In the related art, there is known a technique for correcting a deviation of an ink landing position. For example, JP-A-2015-051511 discloses a printer that corrects a deviation of an ink landing position for each discharge port row by changing a discharge velocity for each discharge port row based on a distance between a discharge port that discharges ink and a drum that transports a printing medium.

In a printer that discharges ink, a work gap, which is a distance between a nozzle surface of a print head and a printing medium, may change by changing a thickness of a printing medium and a positional relationship between the printing medium and the print head. When the work gap changes, a flight distance of ink changes, so that a deviation of an ink landing position may occur. However, since a correction of JP-A-2015-051511 is not a correction that takes into consideration the change of the work gap, there is a possibility that the deviation of the ink landing position cannot be sufficiently corrected.

### SUMMARY

According to an aspect of the present disclosure, there is provided an information processing apparatus including: a storage section that stores a learned model that was trained by machine learning based on a data set in which work gap information indicating a work gap which is a distance between a printing medium and a nozzle surface of a print head, and landing position information related to a deviation of a landing position of ink discharged from the print head are associated; and a processing section that acquires a printing condition, and inputs the work gap information included in the acquired printing condition to the learned model stored in the storage section to cause the learned model to output a correction value for correcting the deviation.

In the information processing apparatus, the storage section may store the learned model that was trained by machine learning based on the data set in which the work gap information, the landing position information, and scanning velocity information indicating a scanning velocity of a carriage on which the print head is mounted are associated, and the processing section may acquire the scanning velocity information included in the printing condition, and further input the acquired scanning velocity information to the learned model to cause the learned model to output the correction value.

In the information processing apparatus, the storage section may store the learned model that was trained by machine learning based on the data set in which the work gap information, the landing position information, at least one of temperature information indicating a temperature of the print head, and waveform information indicating a waveform of a signal input to the print head for discharging ink are associated, and the processing section may acquire at least one of the temperature information and waveform information included in the printing condition, and may further input at least one of the acquired temperature information and waveform information to the learned model to cause the learned model to output the correction value.

In the information processing apparatus, the landing position information may include information related to a work gap error and a mounting error of the print head, and the correction value may include a value for correcting the deviation of the landing position caused by any one of the work gap error, the temperature of the print head, and the mounting error of the print head.

In the information processing apparatus, the print head may have a plurality of nozzle rows, the storage section may store the learned model that was trained by machine learning based on the data set in which the work gap information, the landing position information, and nozzle row information indicating the nozzle row are associated for each nozzle row, and the processing section may further input the nozzle row information to the learned model to cause the learned model to output the correction value.

In the information processing apparatus, a print control section that causes a printing section to print at a discharge timing based on the correction value may be provided.

According to another aspect of the present disclosure, there is provided a learning apparatus including a storage section that stores a learned model that was trained by machine learning based on a data set in which work gap information indicating a work gap which is a distance between a printing medium and a nozzle surface of a print head, and landing position information related to a deviation of a landing position of ink discharged from the print head are associated; and a processing section that acquires a printing condition, and inputs the work gap information included in the acquired printing condition to the learned model stored in the storage section to cause the learned model to output a correction value for correcting the deviation.

In the learning apparatus, a learning section that acquires the data set and updates the learned model stored in the storage section based on the acquired data set may be provided.

In the learning apparatus, the learning section may acquire the data set in which the landing position information indicating a deviation amount of an ink landing position calculated from a photographed image of a pattern image printed by the print head and the work gap information are associated.

According to still another aspect of the present disclosure, there is provided a control method of an information processing apparatus, the method including: storing a learned model that was trained by machine learning based on a data set in which work gap information indicating a work gap which is a distance between a printing medium and a nozzle surface of a print head, and landing position information related to a deviation of a landing position of ink discharged from the print head are associated; acquiring a printing condition; and inputting the work gap information included in the acquired printing condition to the stored learned model to cause the learned model to output a correction value for correcting the deviation.

According to yet still another aspect of the present disclosure, there is provided a program executed by a computer, the program causes the computer to store a learned model that was trained by machine learning based on a data set in which work gap information indicating a work gap which is a distance between a printing medium and a nozzle surface of a print head, and landing position information related to a deviation of a landing position of ink discharged from the print head are associated; acquire a printing condition; and output a correction value for correcting the deviation from the learned model by inputting the work gap information included in the acquired printing condition to the stored learned model.

### BRIEF DESCRIPTION OF THE DRAWINGS

FIG. 1 is a diagram illustrating a configuration of a printing system.

FIG. 2 is a schematic configuration diagram of a printer.

FIG. 3 is a plan diagram illustrating an arrangement of print heads.

FIG. 4 is a diagram illustrating a functional configuration of a printer.

FIG. 5 is a diagram for explaining each component of a discharge timing correction value.

FIG. 6 is a diagram illustrating an example of a data set.

FIG. 7 is a diagram for explaining a landing position deviation amount caused by a discharge velocity.

FIG. 8 is a diagram for explaining a landing position deviation amount caused by a work gap error.

FIG. 9 is a diagram for explaining a landing position deviation amount caused by a mounting error.

FIG. 10 is a diagram illustrating a functional configuration of a server.

FIG. 11 is a diagram illustrating an example of a neural network configuring a learning section.

FIG. 12 is a flowchart illustrating an operation of a printer.

FIG. 13 is a flowchart illustrating an operation of a server.

FIG. 14 is a flowchart illustrating an operation of a printer.

FIG. 15 is a schematic diagram illustrating a configuration of a job group.

FIG. 16 is a diagram illustrating an operation of a printer in discharge timing correction processing.

FIG. 17 is a diagram illustrating a functional configuration of each section of a printing system according to a second embodiment.

FIG. 18 is a diagram illustrating a functional configuration of a printer according to a third embodiment.

### DESCRIPTION OF EXEMPLARY EMBODIMENTS

### 1. First Embodiment

### 1-1. Configuration of Printing System

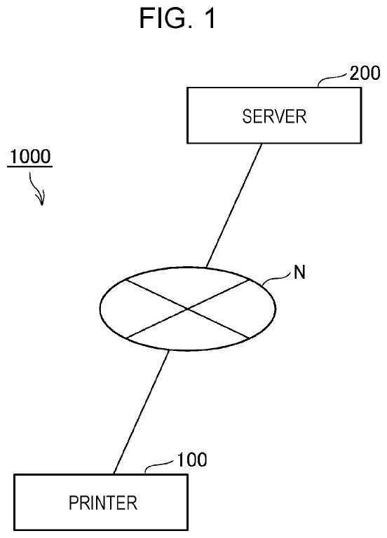

FIG. 1 is a diagram illustrating an example of a printing system 1000.

The printing system 1000 includes a printer 100 and a server 200. In the present embodiment, the printer 100 corresponds to an example of an information processing apparatus. The printer 100 and the server 200 are communicably coupled to each other via a communication network N.

Although FIG. 1 illustrates a case where one printer 100 is coupled to the server 200, the number of printers 100 included in the printing system 1000, that is, the number of printers 100 coupled to the server 200 may be plural. When the printing system 1000 includes a plurality of printers 100, the server 200 identifies the plurality of printers 100 included in the printing system 1000 by identification information and communicates with a target printer 100. As the identification information, a unique ID assigned to each individual printer 100, a network address, or the like can be used.

The communication network N is a public line network, a dedicated line, other communication lines, or a network composed of various communication equipment, and a specific mode thereof is not limited. For example, the communication network N may be a wide area network or a local network installed inside a building. Further, the communication network N may include a wireless communication circuit.

### 1-2. Printer Configuration

Next, a printer 100 will be described.

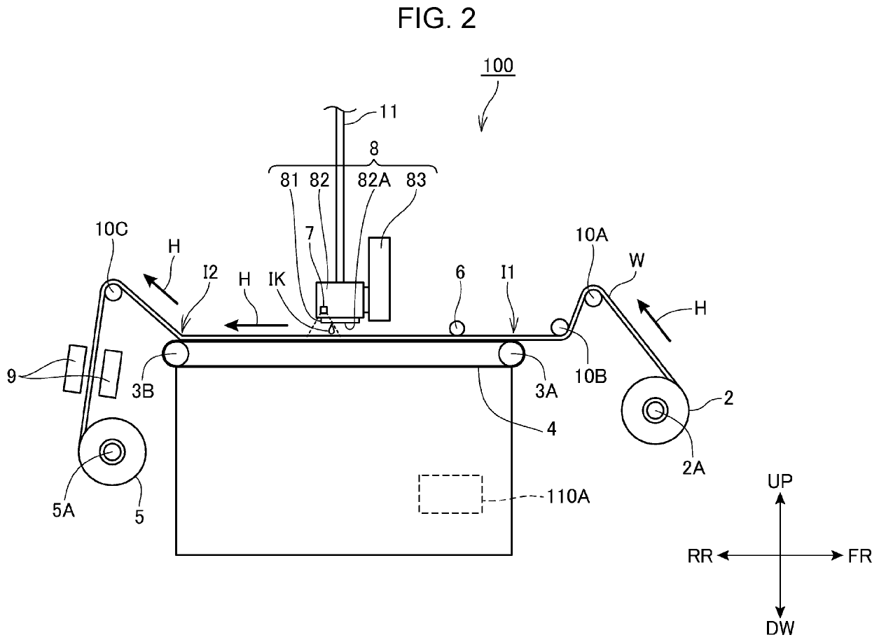

FIG. 2 is a schematic configuration diagram of a printer 100.

In FIGS. 2, 3, 5, 7, 8, and 9, a front side of the printer 100 in the installed state is indicated by a symbol FR, and a rear side of the printer 100 is indicated by a symbol RR. Further, in FIGS. 2, 3, 5, 7, 8, and 9, a right side of the printer 100 is indicated by a symbol R, and a left side of the printer 100 is indicated by a symbol L. Further, in FIGS. 2, 3, 5, 7, 8, and 9, an upper side of the printer 100 is indicated by a symbol UP, and a lower side of the printer 100 is indicated by a symbol DW.

The printer 100 includes a print head unit 81 that discharges ink IK, and the printer 100 is an ink jet printer that discharges the ink IK from the print head unit 81 to print an image on a printing medium W.

The printing medium W is, for example, a cloth made of natural fibers or synthetic fibers. The printer 100 is a textile printing machine that prints on the printing medium W by adhering ink IK to the printing medium W that is a cloth. Therefore, the printing medium W is a material to be printed. In the present embodiment, a cloth is used as an example of the printing medium W. However, as the printing medium W, in addition to a cloth, plain paper, high-quality paper, dedicated paper for ink jet recording such as glossy paper, and the like may be used.

The printer 100 includes a feeding device 2, driven rollers 10A, 10B, and 10C, transport rollers 3A and 3B, a transport belt 4, and a winding device 5. Each of sections configures a transport mechanism 1011 that transports a printing medium W described later.

The feeding device 2 is a device that feeds a long printing medium W wound in a roll shape onto the transport belt 4. The feeding device 2 is positioned on the most upstream side in a transport direction H of the printing medium W. The feeding device 2 rotates a rotary shaft 2A counterclockwise in FIG. 2 to feed the printing medium W set on the rotary shaft 2A onto the transport belt 4 via the driven rollers 10A and 10B.

The transport rollers 3A and 3B are a pair of rollers that drive an endless transport belt 4. For example, the transport roller 3A is a drive roller, and the transport roller 3B is a driven roller. The transport belt 4 is a glue belt in which an adhesive layer having adhesiveness is formed on the surface. The printing medium W fed from the feeding device 2 is adhesively fixed to the adhesive layer of the transport belt 4 and is transported in the transport direction H together with the transport belt 4. Note that, although a glue belt having an adhesive layer formed on the surface is exemplified as the transport belt 4 of the present embodiment, the transport belt 4 is not limited to an adhesive belt and may be, for example, an electrostatic adsorption belt.

The winding device 5 is a device that winds the printing medium W transported by the transport belt 4 via the driven roller 10C. The winding device 5 is positioned on the most downstream side in the transport direction H of the printing medium W. The winding device 5 winds the printing medium W printed by the print head unit 81 in a roll shape on a winding reel set on a rotary shaft 5A, by rotating the rotary shaft 5A counterclockwise in FIG. 2.

The printer 100 includes a pressing roller 6. The pressing roller 6 is provided downstream of a placement start position I1 at which the transport belt 4 starts placing the printing medium W in the transport direction H, and is provided upstream of the print head unit 81 described later. The printing medium W placed on the transport belt 4 is pressed against the transport belt 4 by the pressing roller 6. Thereby, the printer 100 is able to reliably adhere the printing medium W to the adhesive layer formed on the surface of the transport belt 4, and thus floating of the printing medium W placed on the transport belt 4 from the transport belt 4 can be prevented. The pressing roller 6 is configured to be capable of reciprocating along the transport direction H in order to prevent the printing medium W from being marked with rollers.

The printer 100 includes a printing unit 8. The printing unit 8 is provided downstream of the pressing roller 6 in the transport direction H and upstream of a placement end position I2 at which the printing medium W separates from the transport belt 4.

The printing unit 8 includes a carriage 82.

The print head unit 81 is mounted on the carriage 82. The carriage 82 reciprocates in a scanning direction. The scanning direction of the carriage 82 is an intersecting direction K that intersects with the transport direction, which is a direction orthogonal to the transport direction H in the present embodiment, and is a left-right direction of the printer 100. The print head unit 81 reciprocates on the printing medium W together with the carriage 82 in the intersecting direction K. The print head unit 81 prints an image on the printing medium W by discharging ink IK onto the printing medium W in accordance with a movement of the carriage 82.

The print head unit 81 is provided on a lower surface 82A of the carriage 82. The print head unit 81 includes a large number of print heads 811. The print head unit 81 is provided on the lower surface 82A of the carriage 82 in a state where openings of nozzles Nz of each print head 811 face the transport belt 4.

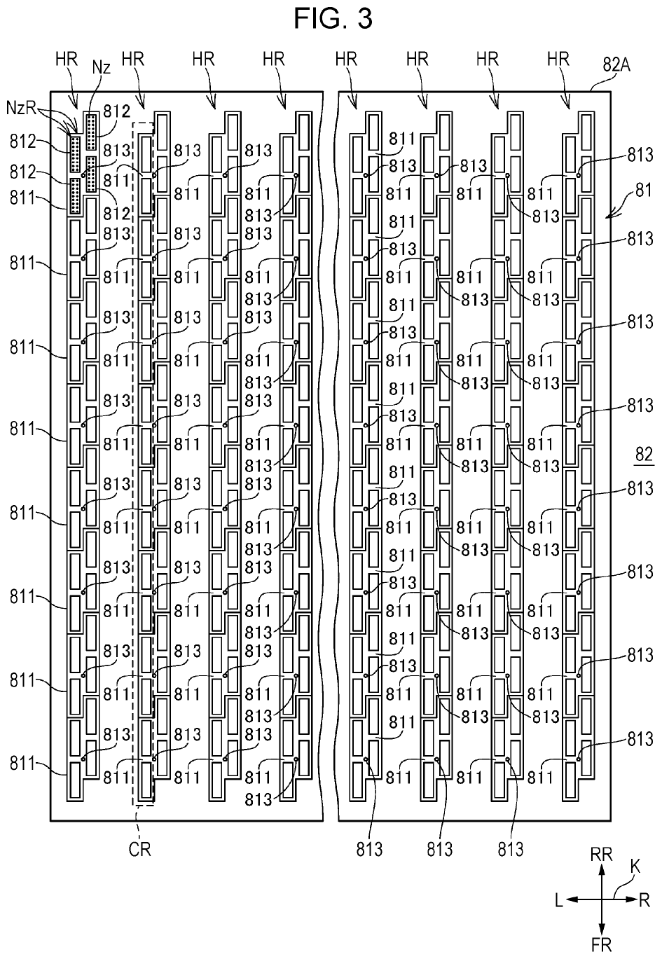

FIG. 3 is a plan diagram illustrating an arrangement of the print heads 811.

As illustrated in FIG. 3, a large number of print heads 811 included in the print head unit 81 are arranged side by side on the lower surface 82A of the carriage 82. In the present embodiment, 64 print heads 811 are arranged on the lower surface 82A of the carriage 82 such that eight head rows HR in which eight print heads 811 are arranged in a front-rear direction are arranged in the left-right direction.

Each print head 811 has a plurality of chips 812. Each print head 811 of the present embodiment has four chips 812. Therefore, the print head unit 81 of the present embodiment has 256 chips 812. Each chip 812 has a plurality of nozzle rows NzR extending in the front-rear direction and an ink flow path (not illustrated). Note that, a piezo element driven by a head drive circuit that drives the print head 811 is disposed in the ink flow path. The head drive circuit drives the piezo element, so that ink IK is discharged from each of the nozzles Nz configuring the nozzle row NzR. In the example of FIG. 2, four chips 812 are arranged in a zigzag pattern, in other words, four chips 812 are arranged in a staggered manner to form one print head 811.

Each chip 812 of the present embodiment forms two rows for one head row HR. In the following description, one row of the chips 812 arranged in the front-rear direction is referred to as a “chip row” and a symbol “CR” is attached. Further, each chip 812 includes two nozzle rows NzR, and two nozzle rows NzR are formed for each chip row CR. The print head unit 81 of the present embodiment has 512 nozzle rows NzR.

The print head unit 81 discharges the same color ink IK from the chips 812 included in the chip row CR. In the present embodiment, 16 chip rows CR are arranged on a head arrangement surface 17. When the print head unit 81 discharges, for example, four color inks IK of cyan (C), magenta (M), yellow (Y), and black (K), four chip rows CR are assigned to each color. When a plurality of chip rows CR are assigned to each color, when the chip rows CR are arranged so that the color allocation to the chip rows CR is symmetrical on the left and right, the order of colors when the carriage 82 moves to the right and when it moves to the left is the same. That is, the four color inks IK adhere to the printing medium W in the same order regardless of the moving direction of the carriage 82. Therefore, there is an advantage that it is possible to prevent color unevenness of the image printed on the printing medium W.

Note that, the ink IK discharged by the print head unit 81 is not limited to the above-described color ink IK, and may be, for example, light cyan, light magenta, orange, green, gray, light gray, white, and metallic ink IK. In addition to the ink IK, the print head unit 81 may be configured to discharge a penetrant liquid onto the printing medium W. The penetrant liquid is a liquid that promotes penetration of the ink IK adhering to the surface of the printing medium W to the rear surface. In this case, the print head unit 81 discharges the penetrant liquid toward the printing medium W at the same time as the discharge of the ink IK or at a timing different from that of the discharge of the ink IK.

In each print head 811, a temperature sensor 813 that detects a temperature of the print head 811 is disposed. Each temperature sensor 813 detects the temperature of the print head 811 arranged and outputs the detected value corresponding to the detected temperature to a control device 110A that controls each section of the printer 100. The control device 110A corresponds to an example of a learning apparatus in the present embodiment.

Returning to the description of FIG. 1, a camera 7 is mounted on the carriage 82. The camera 7 photographs an image of the printing medium W placed on the transport belt 4 while scanning the carriage 82. The camera 7 outputs the photographed image to the control device 110A. The image photographed by the camera 7 may be a still image or a video.

The print head unit 81 includes a gap adjusting mechanism 83. The gap adjusting mechanism 83 is a mechanism that adjusts a work gap WG that is a distance between the printing medium W and the nozzle surface 81A of the print head 811. The gap adjusting mechanism 83 is coupled to the carriage 82 and adjusts the work gap WG by moving the carriage 82 in the vertical direction under the control of the control device 110A.

The printer 100 includes a drying unit 9. The drying unit 9 is provided upstream of the winding device 5 and downstream of the driven roller 10C in the transport direction H. Note that, the drying unit 9 need not be provided downstream of the driven roller 10C as long as it is upstream of the winding device 5 and downstream of the print head 811 in the transport direction H. The drying unit 9 has, for example, a chamber that accommodates the printing medium W and a heater that is disposed inside the chamber, and dries undried ink IK on the printing medium W by the heat of the heater.

### 1-3. Functional Configuration of Printer

Next, the functional configuration of the printer 100 will be described.

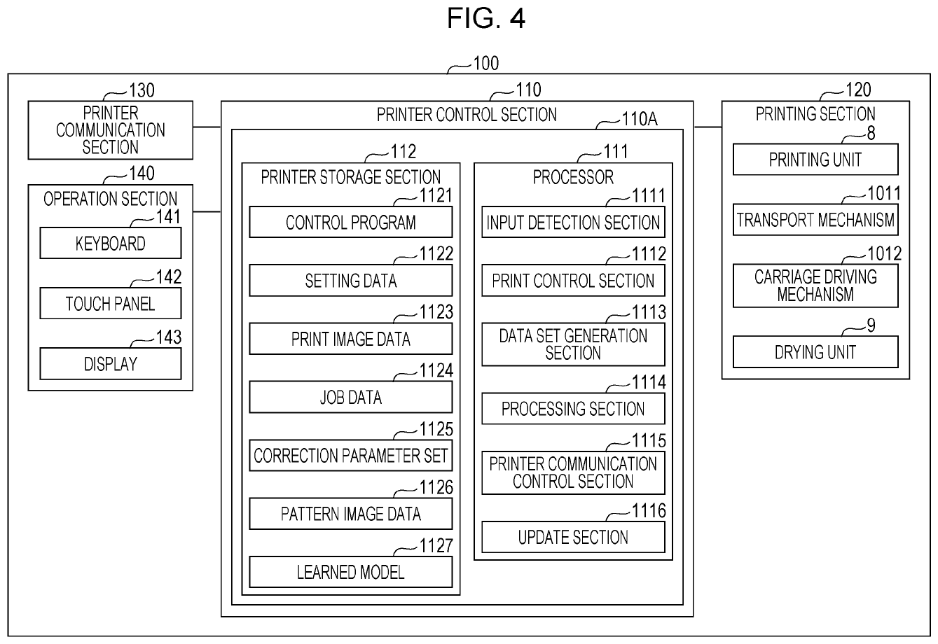

FIG. 4 is a block diagram illustrating the functional configuration of the printer 100.

The printer 100 includes a printer control section 110.

The printer control section 110 includes a control device 110A, which is a computer, and controls each section of the printer 100. The control device 110A includes a processor 111 that executes programs of a CPU or an MPU, and a printer storage section 112. The control device 110A of the present embodiment corresponds to an example of a learning apparatus.

The printer control section 110 executes various processing by cooperation of hardware and software so that the processor 111 reads a control program 1121 stored in the printer storage section 112 and executes processing. In the present embodiment, the printer storage section 112 corresponds to an example of a storage section. Further, in the present embodiment, the control program 1121 corresponds to an example of a program. The printer control section 110 functions as an input detection section 1111, a print control section 1112, a data set generation section 1113, a processing section 1114, a printer communication control section 1115, and an update section 1116 by the processor 111 reading and executing the control program 1121. Details of these functional sections will be described later.

The printer storage section 112 has a storage area for storing a program executed by the processor 111 and data processed by the processor 111. The printer storage section 112 stores a control program 1121 executed by the processor 111 and setting data 1122 including various setting values related to the operation of the printer 100. The printer storage section 112 has a non-volatile storage area for storing programs or data in a non-volatile manner. Further, the printer storage section 112 may include a volatile storage area and may be configured to temporarily store a program executed by the processor 111 and data to be processed.

The printer 100 includes a printing section 120.

The printing section 120 includes a printing unit 8, a transport mechanism 1011, a carriage driving mechanism 1012, and a drying unit 9. The transport mechanism 1011 is a mechanism that transports the printing medium W, and includes a feeding device 2, driven rollers 10A, 10B, and 10C, transport rollers 3A and 3B, a transport belt 4, a winding device 5, and a motor that drives these. The carriage driving mechanism 1012 is a mechanism that reciprocates the carriage 82 in the scanning direction, and includes, for example, a motor as a drive source, a guide member that guides the movement of the carriage 82, gears and links that transmit the power of the motor to the carriage 82, and the like.

The printer 100 includes a printer communication section 130.

The printer communication section 130 is configured by communication hardware such as a connector that complies with a predetermined communication standard and an interface circuit, and communicates with an external device of the printer 100 under the control of the printer control section 110. In the present embodiment, the external device of the printer 100 includes a server 200. When the printer communication section 130 receives print image data 1123 from the external device, the printer control section 110 stores the received print image data 1123 in the printer storage section 112. Further, when the printer communication section 130 receives job data 1124 instructing printing from the external device, the printer control section 110 stores the received job data 1124 in the printer storage section 112.

The printer 100 includes an operation section 140.

The operation section 140 includes a keyboard 141, a touch panel 142, and a display 143. The operation section 140 may include only one of the keyboard 141 and the touch panel 142. The keyboard 141 has a plurality of keys operated by an operator, and outputs operation data indicating the operated keys to the printer control section 110. The display 143 has a display screen such as a liquid crystal display (LCD) and displays an image under the control of the printer control section 110. The touch panel 142 is disposed so as to overlap the display screen of the display 143, detects a touch operation on the display screen, and outputs operation data indicating a touch position to the printer control section 110.

### 1-4. Functional Section of Printer Control Section

The functional sections of the printer control section 110 will be described.

The printer control section 110 includes an input detection section 1111, a print control section 1112, a data set generation section 1113, a processing section 1114, a printer communication control section 1115, and an update section 1116 as functional blocks.

Further, the printer control section 110 includes a printer storage section 112. The printer storage section 112 stores a control program 1121, setting data 1122, print image data 1123, job data 1124, a correction parameter set 1125, pattern image data 1126, and a learned model 1127.

### 1-4-1. Input Detection Section

The input detection section 1111 detects an operator's input operation based on operation data input from the keyboard 141 and the touch panel 142, and executes processing corresponding to the detected operator's input operation.

### 1-4-2. Print Control Section

The print control section 1112 controls the printing section 120 according to the job data 1124 that is data related to a print job IJ, and causes the printing section 120 to print on the printing medium W. Further, the print control section 1112 causes the printing section 120 to print a pattern image PT on the printing medium W based on the pattern image data 1126.

The job data 1124 will be described later.

The pattern image data 1126 is data of the pattern image PT for correcting a discharge timing of ink IK.

The print control section 1112 calculates a discharge timing correction value that is a correction value of a discharge timing of ink IK for each nozzle row NzR. Then, the print control section 1112 corrects the discharge timing of the ink IK based on the calculated discharge timing correction value for each nozzle row NzR, and causes the printing section 120 to print an image on the printing medium W.

The discharge timing correction value will be described in detail.

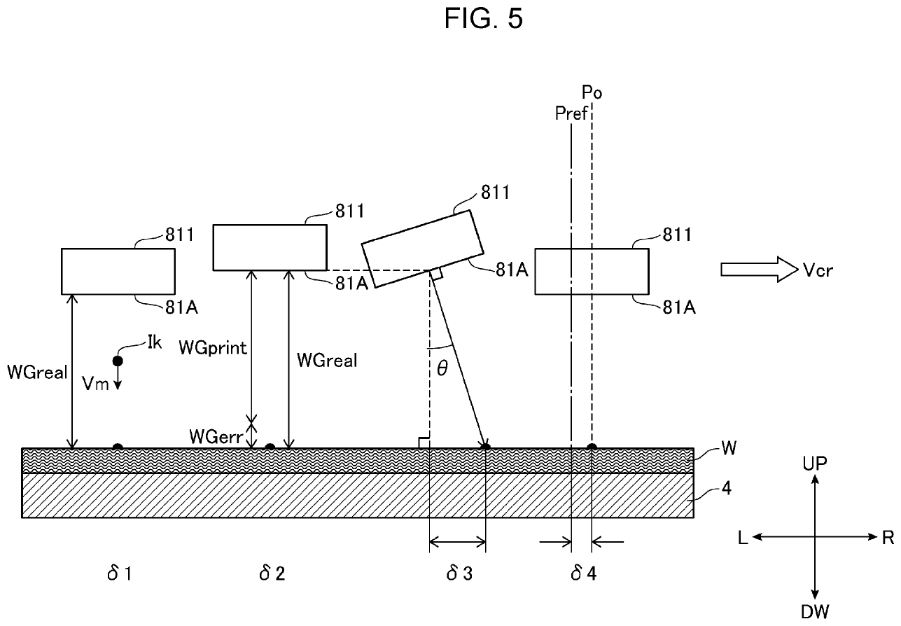

FIG. 5 is a diagram for explaining the components that configure the discharge timing correction value.

Each symbol illustrated in FIG. 5 is attached to a corresponding wording in the description after FIG. 5.

In FIG. 5, four components, that is, a first component to a fourth component, which constitute the discharge timing correction value, are illustrated.

In FIG. 5, a symbol δ1 indicates a first component. A symbol δ2 indicates a second component. A symbol δ3 indicates a third component. A symbol δ4 indicates a fourth component.

Further, in FIG. 5, a symbol PO indicates an actual mounting position of the print head 811 in the intersecting direction K.

Further, in FIG. 5, a symbol Pref indicates a reference position of the mounting position of the print head 811 in the intersecting direction K. Note that, a print head 811 to be compared with a print head 811 positioned at the reference position is a print head 811 belonging to the same head row HR as the print head 811 positioned at the reference position.

Further, in FIG. 5, a symbol Vcr indicates a moving velocity of the print head 811, that is, a scanning velocity of the carriage 82. In the following description, the scanning velocity of the carriage 82 is simply referred to as “scanning velocity” and a symbol “Vcr” is attached.

Further, in FIG. 5, a symbol Vm indicates a discharge velocity of ink IK, that is, a velocity at which the ink IK flies in the air. In the following description, the discharge velocity of the ink IK is simply referred to as “discharge velocity” and a symbol “Vm” is attached.

Further, in FIG. 5, a symbol WGreal indicates an actual work gap WG. In the following description, the actual work gap WG is referred to as an actual work gap, and a symbol “WGreal” is attached.

Further, in FIG. 5, a symbol WGprint indicates a work gap WG set in the printing condition. In the following description, the work gap WG set in the printing condition is referred to as a set work gap, and a symbol “WGprint” is attached.

Further, in FIG. 5, the symbol WGerr indicates a work gap error which is an error of the actual work gap WGreal with respect to the set work gap WGprint. The work gap error WGerr is represented by a difference between the set work gap WGprint and the actual work gap WGreal.

A symbol θ indicates a tilt error of the print head 811.

In FIG. 5, four print heads 811 are illustrated for convenience in order to explain each of four components of the first component δ1 to the fourth component δ4 that constitute the discharge timing correction value.

In the present embodiment, the discharge timing correction value is represented by a sum of the first component δ1 to the fourth component δ4 as indicated by the following Equation (1).

$$\begin{matrix}δ total = δ1 + δ2 + δ3 + δ4 & ( 1 ) \\ δ1 = \frac{WGprint}{Vm} \times Vcr & ( 2 ) \\ δ2 = \frac{WGerr}{Vm} \times Vcr & ( 3 ) \\ δ3 = WGreal \times tan θ & ( 4 ) \\ δ4 = TRerr & ( 5 )\end{matrix}$$

In Equation (1), δtotal indicates a discharge timing correction value. In the following description, a symbol “δtotal” is attached to the discharge timing correction value.

The first component δ1 to the fourth component δ4 are represented by Equations (2) to (5).

As indicated in Equation (2), the first component δ1 is calculated by dividing a set work gap WGprint by a discharge velocity Vm and multiplying by a scanning velocity Vcr. The first component δ1 indicates a difference between a landing position of ink IK when the scanning velocity Vcr is assumed to be zero and a landing position when the scanning velocity Vcr is not zero.

As indicated in Equation (3), the second component δ2 is calculated by dividing a work gap error WGerr by a discharge velocity Vm and multiplying by the scanning velocity Vcr.

As indicated in Equation (4), the third component δ3 is a value obtained by multiplying the work gap WGreal by tan θ. Note that, the tilt error θ of the print head 811 corresponds to a tilt error of the print head 811 with respect to the vertical direction, and also corresponds to a tilt error of the print head 811 with the front-rear direction as a rotation axis. The tilt error θ of the print head 811 is measured in advance for each print head 811 before the printer 100 is shipped.

In Equation (5), TRerr indicates a mounting error of the print head 811 in the intersecting direction K. Therefore, the fourth component δ4 indicates the mounting error of the print head 811 in the intersecting direction K. In FIG. 5, a difference between a reference mounting position Pref of the print head 811 and an actual mounting position PO of the print head 811 indicates a mounting error of the print head 811 in the intersecting direction K. In the following description, the mounting error of the print head 811 in the intersecting direction K will be simply referred to as the “mounting error” and a symbol “TRerr” is attached.

The print control section 1112 causes the printing section 120 to print the print job IJ and the pattern image PT based on the correction parameter set 1125 stored in the printer storage section 112 and the printing condition.

The correction parameter set 1125 includes values of the discharge velocity Vm, the work gap error WGerr, the mounting error TRerr of the print head 811 to which the nozzle row NzR belongs, and the tilt error θ of the print head 811 to which the nozzle row NzR belongs, for each of the nozzle rows NzR included in the print head unit 81. In the correction parameter set 1125, the values of the discharge velocity Vm, the work gap error WGerr, and the mounting error TRerr are appropriately updated for each nozzle row NzR as described later.

Here, the calculation of the discharge timing correction value δtotal when the print control section 1112 causes the printing section 120 to print the pattern image PT will be described. The calculation of the discharge timing correction value δtotal in printing based on the print job IJ will be described later.

The print control section 1112 calculates a value of the first component δ1 by substituting the discharge velocity Vm of the correction parameter set 1125, the set work gap WGprint in the most recent printing, and the scanning velocity Vcr set in the printing condition in the most recent printing into Equation (2).

Further, the print control section 1112 calculates a value of the second component δ2 by substituting the discharge velocity Vm of the correction parameter set 1125, the work gap error WGerr of the correction parameter set 1125, and the scanning velocity Vcr set in the printing condition in the most recent printing into Equation (3).

Further, the print control section 1112 calculates the value of the third component δ3 by substituting the tilt error θ of the print head 811 of the correction parameter set 1125 and the actual work gap WGreal into Equation (4). Here, the actual work gap WGreal that is substituted into Equation (4) is calculated by adding the set work gap WGprint in the most recent printing and the work gap error WGerr of the correction parameter set 1125.

Then, the print control section 1112 substitutes the calculated values of the first component δ1 to the third component δ3 into Equation (1), and substitutes the mounting error TRerr of the correction parameter set 1125 into Equation (1) as the value of the fourth component δ4 to calculate the discharge timing correction value δtotal.

### 1-4-3. Data Set Generation Section

The data set generation section 1113 generates a data set 2123 which is data for the learning section 2112 of the server 200 to learn.

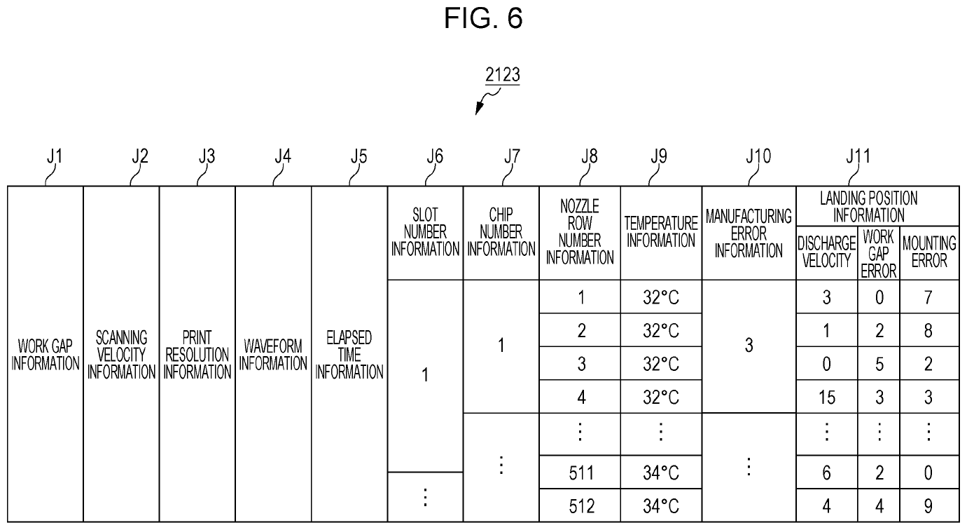

FIG. 6 is a diagram illustrating an example of the data set 2123.

The data set 2123 is data in which landing position information J11 related to a landing position deviation of ink IK and information having a correlation with the landing position deviation of the ink IK are associated.

The data set 2123 includes the landing position information J11. The landing position information J11 will be described later.

The data set 2123 includes work gap information J1, scanning velocity information J2, print resolution information J3, waveform information J4, elapsed time information J5, slot number information J6, chip number information J7, nozzle row number information J8, temperature information J9, and manufacturing error information J10 as information having a correlation with the landing position deviation of the ink IK. The nozzle row number information J8 corresponds to an example of nozzle row information.

The work gap information J1 included in the data set 2123 is information indicating the set work gap WGprint included in the printing condition of the pattern image PT described later. When the work gap WG changes, a flight distance of the ink IK changes. When the flight distance of the ink IK changes, an air resistance that the ink IK receives during flight changes. As a result, when the work gap WG changes, the landing position of the ink IK deviates. Therefore, in the data set 2123, the work gap information J1 is included as information having a correlation with the landing position deviation of the ink IK.

The scanning velocity information J2 included in the data set 2123 is information indicating the scanning velocity Vcr set in the printing condition of the pattern image PT described later. When the scanning velocity Vcr changes, the air resistance that the ink IK receives during flight also changes. As a result, when the scanning velocity Vcr changes, the landing position of the ink IK deviates. Therefore, in the data set 2123, the scanning velocity information J2 is included as information having a correlation with the landing position deviation of the ink IK.

The print resolution information J3 included in the data set 2123 is information indicating the print resolution set in the printing condition of the pattern image PT described later. Since the size of the ink IK changes when the print resolution changes, the air resistance that the ink IK receives during flight changes when the print resolution changes. Therefore, when the print resolution changes, the landing position of the ink IK deviates. Therefore, the data set 2123 includes the print resolution information J3 as information having a correlation with the landing position deviation of the ink IK.

The waveform information J4 included in the data set 2123 is information indicating an ink discharge waveform set in the printing condition of the pattern image PT described later. The ink discharge waveform is a waveform of a signal input to the print head 811 for discharging the ink IK, and is a waveform that determines the size of one dot of the ink IK. In the ink discharge waveform, ON signals for driving piezo elements are included in the number corresponding to the size of one dot of the ink IK. Since the size of the ink IK changes when the ink discharge waveform changes, the air resistance that the ink IK receives during flight also changes when the ink discharge waveform changes. Therefore, when the ink discharge waveform changes, the landing position of the ink IK deviates. Therefore, in the data set 2123, the waveform information J4 is included as information having a correlation with the landing position deviation of the ink IK.

The elapsed time information J5 included in the data set 2123 is information indicating the elapsed time since the printer 100 was used. Due to the aged deterioration of the printer 100, a deviation may occur in the landing position of the ink IK. Therefore, in the data set 2123, the elapsed time information J5 is included as information having a correlation with the landing position deviation of the ink IK.

The slot number information J6 is information indicating the slot number. The slot number is a number for identifying a reservoir of the ink IK. The printer 100 has a plurality of reservoirs, and different slot numbers are assigned to the reservoirs. In many cases, the printer 100 has a plurality of ink IK reservoirs and stores ink IK having different colors for each of the reservoirs. When the color of the ink IK is different, the weight of the ink IK per dot may be different due to the color component. Therefore, even with the same nozzle row NzR, when the color of the ink IK discharged by the nozzle row NzR changes, the landing position of the ink IK deviates. Therefore, in the data set 2123, the slot number information J6 is included as information having a correlation with the landing position deviation of the ink IK.

The chip number information J7 is information indicating the chip number. The chip number is a number for identifying the chip 812. Each chip 812 is assigned a different chip number. In the print head 811 to which the chip 812 belongs, a mounting error TRerr may occur. Therefore, in the data set 2123, the chip number information J7 is included as information having a correlation with the landing position deviation of the ink IK.

The nozzle row number information J8 is information indicating the nozzle row number. The nozzle row number is a number for identifying the nozzle row NzR. Different nozzle row numbers are assigned to the respective nozzle rows NzR. The mounting error TRerr may occur depending on the print head 811 to which the nozzle row NzR belongs. Therefore, in the data set 2123, the nozzle row number information J8 is included as information having a correlation with the landing position deviation of the ink IK.

The temperature information J9 is information indicating the temperature of the print head 811. Since the viscosity of the ink IK changes when the temperature of the print head 811 changes, the discharge velocity Vm changes when the temperature of the print head 811 changes. Therefore, when the temperature of the print head 811 changes, the landing position of the ink IK deviates. Therefore, in the data set 2123, the temperature information J9 is included as information having a correlation with the landing position deviation of the ink IK.

The manufacturing error information J10 is information indicating a manufacturing error that is an alignment deviation between the chips 812 in the print head 811. The alignment deviation is obtained in advance for each chip 812. The alignment deviation causes a relative positional deviation between the printing medium W and the nozzle row NzR, which becomes a factor of a landing position deviation of the ink IK. Therefore, in the data set 2123, the manufacturing error information J10 is included as information having a correlation with the landing position deviation of the ink IK.

The landing position information J11 is information indicating a deviation amount of the landing position caused by the discharge velocity Vm, the work gap error WGerr, and the mounting error TRerr. In the following description, the “deviation amount of the landing position” is referred to as the “landing position deviation amount”. The landing position deviation amount is a value used to calculate the discharge timing correction value δtotal, and thus corresponds to an example of a correction value for correcting the landing position deviation. Since the discharge velocity Vm changes as the temperature of the print head 811 changes, the landing position deviation amount caused by the discharge velocity Vm corresponds to the landing position deviation amount caused by the temperature of the print head 811.

The landing position information J11 includes the landing position deviation amount caused by the discharge velocity Vm, the work gap error WGerr, and the mounting error TRerr, respectively, for each nozzle row NzR.

The landing position information J11 includes information indicating the deviation amount between a first sub-pattern image PT-1 and a second sub-pattern image PT-2 in the pattern image PT, as information indicating the landing position deviation amount. In the following description, the deviation amount between the first sub-pattern image PT-1 and the second sub-pattern image PT-2 is referred to as “pattern deviation amount”.

The first sub-pattern image PT-1 and the second sub-pattern image PT-2 are straight line images extending in the transport direction H by the length of the nozzle row NzR. Note that, in the present embodiment, each of the first sub-pattern image PT-1 and the second sub-pattern image PT-2 exemplifies one straight line image, but may be an image including a plurality of straight lines such as ruled lines.

The data set generation section 1113 acquires the landing position deviation amount caused by the discharge velocity Vm from a discharge velocity pattern image. The discharge velocity pattern image is a pattern image PT for obtaining the landing position deviation amount caused by the discharge velocity Vm.

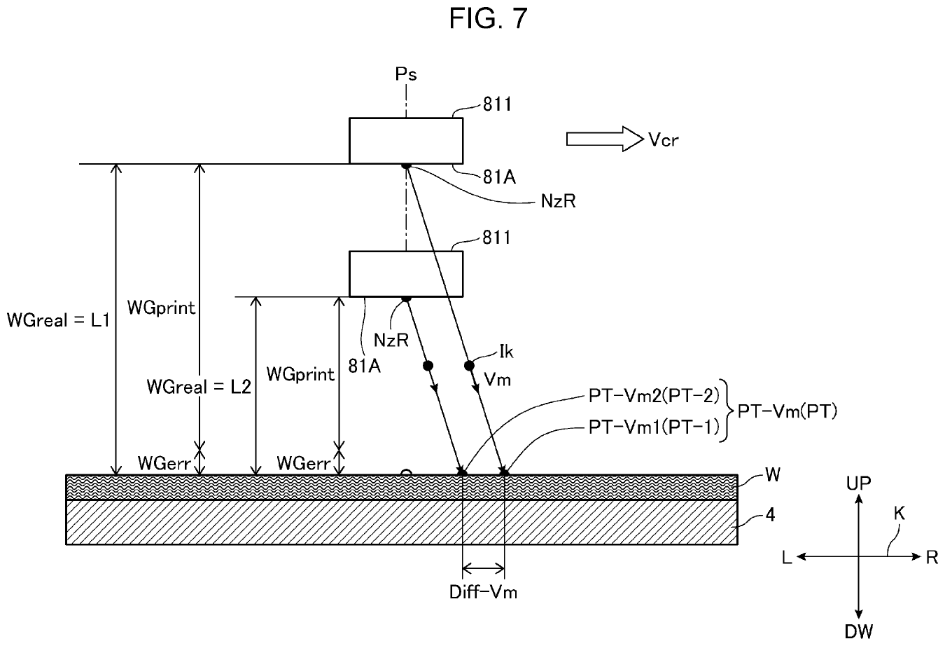

FIG. 7 is a diagram for explaining the landing position deviation amount caused by the discharge velocity Vm.

Each symbol illustrated in FIG. 7 is attached to the corresponding wording in the description after FIG. 7.

In FIG. 7, a symbol PT-Vm indicates a discharge velocity pattern image.

Further, in FIG. 7, a symbol PT-Vm1 indicates the first sub-pattern image PT-1 that configures the discharge velocity pattern image PT-Vm.

Further, in FIG. 7, a symbol PT-Vm2 indicates the second sub-pattern image PT-1 that configures the discharge velocity pattern image PT-Vm.

Further, in FIG. 7, Diff-Vm indicates a separation distance between the first sub-pattern image PT-Vm1 and the second sub-pattern image PT-Vm2 in the intersecting direction K. The separation distance Diff-Vm indicates the pattern deviation amount in the discharge velocity pattern image PT-Vm, and indicates the landing position deviation amount caused by the discharge velocity Vm.

Further, in FIG. 7, a symbol Ps indicates a discharge position in the intersecting direction K at which the nozzle row NzR discharges the ink IK when printing the pattern image PT. The discharge position Ps is a position which is different for each nozzle row NzR.

The data set generation section 1113 instructs the print control section 1112 to print the discharge velocity pattern image PT-Vm.

The print control section 1112 prints the first sub-pattern image PT-Vm1 in a state where the actual work gap WGreal has a value of “L1”, and transports the printing medium W by the length of the nozzle row NzR in the transport direction H, and prints the second sub-pattern image PT-Vm2 in a state where the actual work gap WGreal has a value of “L2” different from “L1”. The print control section 1112 prints the first sub-pattern image PT-Vm1 based on the set work gap WGprint of the most recent printing, and prints the second sub-pattern image PT-Vm2 based on the set work gap WGprint obtained by subtracting a predetermined value from the set work gap WGprint.

At the time of printing, the nozzle row NzR that prints the discharge velocity pattern image PT-Vm discharges the ink IK at the timing when the nozzle row NzR reaches the discharge position Ps, and prints the first sub-pattern image PT-Vm1 and the second sub-pattern image PT-Vm2. The scanning directions of the carriage 82 when printing the first sub-pattern image PT-Vm1 and when printing the second sub-pattern image PT-Vm2 are the same. In a case of FIG. 7, the carriage 82 scans to the right, and the nozzle row NzR prints the discharge velocity pattern image PT-Vm. Further, the scanning velocity Vcr of the carriage 82 when printing the first sub-pattern image PT-Vm1 and the scanning velocity Vcr of the carriage 82 when printing the second sub-pattern image PT-Vm2 are the same, and they are the scanning velocities Vcr set in the printing condition in the most recent printing.

The data set generation section 1113 instructs the print control section 1112 to print to cause the discharge velocity pattern image PT-Vm to be printed on the printing medium W for each nozzle row NzR.

Next, the data set generation section 1113 photographs each of the discharge velocity pattern images PT-Vm printed by the print control section 1112 with the camera 7, and acquires a photographed image for each discharge velocity pattern image PT-Vm. Next, the data set generation section 1113 calculates the separation distance Diff-Vm in the intersecting direction K from the photographed image for each nozzle row NzR. Then, the data set generation section 1113 stores the calculated separation distance Diff-Vm in the data set 2123 as the landing position deviation amount caused by the discharge velocity Vm in association with an appropriate nozzle row number.

Note that, the separation distance Diff-Vm is calculated based on the photographing magnification of the camera 7 and the number of pixels corresponding to the separation distance between the first sub-pattern image PT-Vm1 and the second sub-pattern image PT-Vm2 are separated from each other in the photographed image.

The data set generation section 1113 acquires the landing position deviation amount caused by the work gap error WGerr from the work gap error pattern image. The work gap error pattern image is a pattern image PT for obtaining the landing position deviation amount caused by the work gap error WGerr.

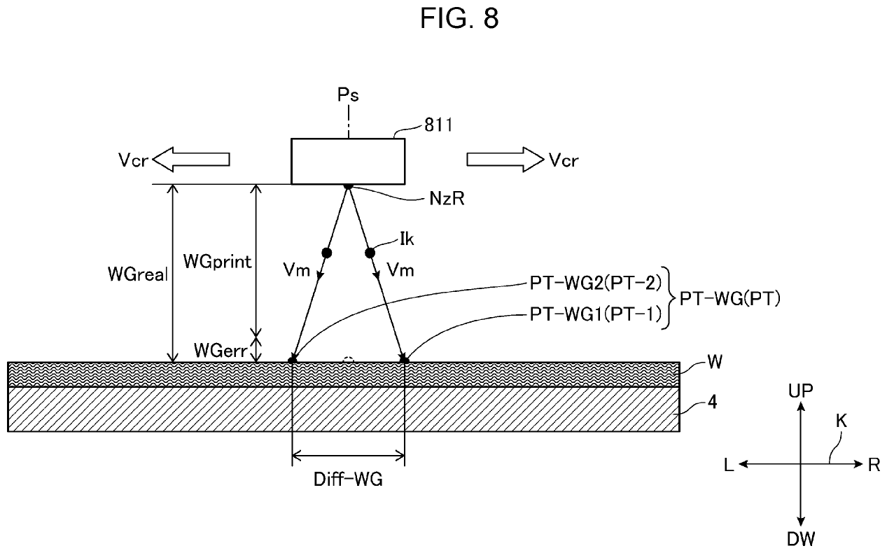

FIG. 8 is a diagram for explaining the landing position deviation amount caused by the work gap error.

Each symbol illustrated in FIG. 8 is attached to the corresponding wording in the description after FIG. 8.

In FIG. 8, a symbol PT-WG indicates a work gap error pattern image.

Further, in FIG. 8, a symbol: PT-WG1 indicates the first sub-pattern image PT-1 that configures the work gap error pattern image.

Further, in FIG. 8, a symbol PT-WG2 indicates the second sub-pattern image PT-2 that configures the work gap error pattern image.

Further, in FIG. 8, a symbol Diff-WG indicates a separation distance in the intersecting direction K between the first sub-pattern image PT-WG1 and the second sub-pattern image PT-WG2. The separation distance Diff-WG indicates a pattern deviation amount in the work gap error pattern image PT-WG, and indicates a landing position deviation amount caused by the work gap error WGerr.

The data set generation section 1113 instructs the print control section 1112 to print the work gap error pattern image PT-WG.

The print control section 1112 prints the first sub-pattern image PT-WG1 while moving the carriage 82 in one direction of the intersecting direction K, and transports the printing medium W by the length of the nozzle row NzR in the transport direction H to print the second sub-pattern image PT-WG2 while moving the carriage 82 in the other direction of the intersecting direction K.

At the time of printing, the first sub-pattern image PT-WG1 and the second sub-pattern image PT-WG2 are printed by discharging the ink IK from the nozzle rows NzR at the timing when the nozzle rows NzR reach the same discharge position Ps. Further, the set work gap WGprint is the set work gap WGprint of the most recent printing. The scanning velocity Vcr is the scanning velocity Vcr set in the printing condition in the most recent printing.

The data set generation section 1113 instructs the print control section 1112 to print to cause the work gap error pattern image PT-WG to be printed on the printing medium W for each nozzle row NzR.

The data set generation section 1113 photographs each of the work gap error pattern images PT-WG printed by the print control section 1112 with the camera 7, and acquires a photographed image for each work gap error pattern image PT-WG. Next, the data set generation section 1113 calculates the separation distance Diff-WG in the intersecting direction K from the photographed image for each nozzle row NzR. Then, the data set generation section 1113 stores the calculated separation distance Diff-WG in the data set 2123 as the landing position deviation amount caused by the work gap error WGerr in association with an appropriate nozzle row number.

Note that, the separation distance Diff-WG is calculated based on the photographing magnification of the camera 7 and the number of pixels corresponding to the separation distance between the first sub-pattern image PT-WG1 and the second sub-pattern image PT-WG2 in the photographed image.

The data set generation section 1113 acquires the landing position deviation amount caused by the mounting error TRerr from the mounting error pattern image. The mounting error pattern image is a pattern image PT for obtaining the landing position deviation amount caused by the mounting error TRerr.

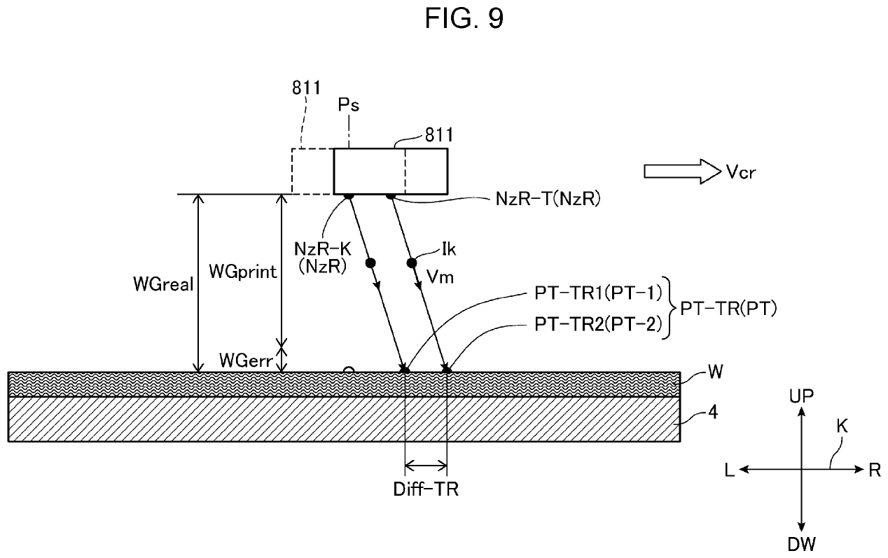

FIG. 9 is a diagram for explaining the landing position deviation amount caused by the mounting error TRerr.

Each symbol illustrated in FIG. 9 is attached to the corresponding wording in the description after FIG. 9.

In FIG. 9, a symbol PT-TR indicates a mounting error pattern image.

Further, in FIG. 9, a symbol PT-TR1 indicates the first sub-pattern image PT-1 that configures the mounting error pattern image PT-TR.

Further, in FIG. 9, a symbol PT-TR2 indicates a second sub-pattern image PT-2 that configures the mounting error pattern image PT-TR.

Further, in FIG. 9, Diff-TR indicates a separation distance between the first sub-pattern image PT-TR1 and the second sub-pattern image PT-TR2 in the intersecting direction K. The separation distance Diff-TR indicates a pattern deviation amount in the mounting error pattern image PT-TR, and indicates a landing position deviation amount caused by the mounting error TRerr.

The data set generation section 1113 instructs the print control section 1112 to print the mounting error pattern image PT-TR.

The print control section 1112 defines a target nozzle row NzR-T which is a target nozzle row NzR for calculating the separation distance Diff-TR and a reference nozzle row NzR-K that is a reference of the target nozzle row NzR-T among the nozzle rows NzR arranged in the front-rear direction with the target nozzle row NzR-T.

Next, the print control section 1112 prints the first sub-pattern image PT-TR1 by the reference nozzle row NzR-K, and transports the printing medium W by the length of the nozzle row NzR in the transport direction H to print the second sub-pattern image PT-TR2 by the target nozzle row NzR-T.

The print head 811 having the target nozzle row NzR-T and the print head 811 having the reference nozzle row NzR-K discharge the ink IK at the timing when they reach the same discharge position Ps, so that the first sub-pattern image PT-TR1 and the second sub-pattern image PT-TR2 are printed. The scanning velocity Vcr when printing the first sub-pattern image PT-TR1 and the scanning velocity Vcr when printing the second sub-pattern image PT-TR2 are the same, and they are the scanning velocities Vcr set in the printing condition in the most recent printing.

The data set generation section 1113 instructs the print control section 1112 to print to cause the mounting error pattern image PT-TR to be printed on the printing medium W for each nozzle row NzR. Note that, when printing the mounting error pattern image PT-TR for each nozzle row NzR, the print control section 1112 defines only one reference nozzle row NzR-K for each of the nozzle rows NzR arranged in the front-rear direction.

Next, the data set generation section 1113 photographs each of the mounting error pattern images PT-TR printed by the print control section 1112 with the camera 7, and acquires a photographed image for each mounting error pattern images PT-TR. Next, the data set generation section 1113 calculates the separation distance Diff-TR from the photographed image in the intersecting direction K for each nozzle row NzR. Then, the data set generation section 1113 stores the calculated separation distance Diff-TR in the data set 2123 as the landing position deviation amount caused by the mounting error TRerr, in association with an appropriate nozzle row number.

Note that, the separation distance Diff-TR is calculated based on the photographing magnification of the camera 7 and the number of pixels corresponding to the separation distance between the first sub-pattern image PT-TR1 and the second sub-pattern image PT-TR2 in the photographed image.

In this way, the data set generation section 1113 calculates three types of pattern deviation amounts from the photographed image for each nozzle row NzR, and stores the calculated pattern deviation amounts as the landing position deviation amounts in the data set 2123.

Further, the data set generation section 1113 stores the work gap information J1, the scanning velocity information J2, the print resolution information J3, and the waveform information J4 included in the printing condition in the most recent printing in the data set 2123.

Further, the data set generation section 1113 acquires elapsed time information J5 indicating the elapsed time of use of the printer 100 when the pattern image PT is printed, and stores the acquired elapsed time information J5 in the data set 2123. The elapsed time of use of the printer 100 is the elapsed time since the start of use of the printer 100, and is counted by the function of the printer control section 110.

Further, the data set generation section 1113 stores the slot number information J6, the chip number information J7, and the nozzle row number information J8 in the data set 2123. When storing the slot number information J6, the chip number information J7, and the nozzle row number information J8, the data set generation section 1113 stores them so that the correspondence relationship with the landing position deviation amount obtained from the pattern image PT becomes appropriate.

Further, the data set generation section 1113 acquires the temperature of the print head 811 when the pattern image PT is printed from each temperature sensor 813, and stores the temperature information J9 indicating the acquired temperature in the data set 2123 so that the temperature information J9 appropriately corresponds to the nozzle row number.

Further, the data set generation section 1113 acquires the manufacturing error information J10 for each chip 812, and stores the acquired manufacturing error information J10 in the data set 2123 so that the manufacturing error information J10 appropriately corresponds to the chip number.

### 1-4-4. Processing Section

When starting printing, the processing section 1114 acquires work gap information J1, scanning velocity information J2, print resolution information J3, and waveform information J4 included in the printing condition indicated by printing condition information JJ described later. The processing section 1114 also acquires elapsed time information J5 when starting printing. The processing section 1114 also acquires temperature information J9 from each temperature sensor 813. Further, the processing section 1114 acquires manufacturing error information J10 for each chip 812. Then, the processing section 1114 inputs these pieces of information to the learned model 1127, and outputs the landing position deviation amount caused by the discharge velocity Vm, the landing position deviation amount caused by the work gap error WGerr, and the landing position deviation amount caused by the mounting error TRerr for each nozzle row NzR. Since the processing section 1114 outputs the information for each nozzle row NzR, in addition to these pieces of information as inputs to the learned model 1127, the processing section 1114 inputs the nozzle row number information J8 of the nozzle row NzR to be output, the chip number information J7 of the chip 812 to which the nozzle row NzR belongs, and the slot number information J6 of the reservoir that supplies the ink IK discharged from the nozzle row NzR.

The learned model 1127 is a trainedmodel by machine learning based on the data set 2123. The same applies to the learned model 2124. The learned models 1127 and 2124 include work gap information J1, scanning velocity information J2, print resolution information J3, waveform information J4, elapsed time information J5, slot number information J6, chip number information J7, nozzle row number information J8, temperature information J9, and manufacturing error information J10 as inputs, and are a model that outputs the landing position deviation amount caused by the discharge velocity Vm, the landing position deviation amount caused by the work gap error WGerr, and the landing position deviation amount caused by the mounting error TRerr. The learned model 1127 is configured as a program executed by the processing section 1114.

### 1-4-5. Printer Communication Control Section

The printer communication control section 1115 transmits the data set 2123 generated by the data set generation section 1113 to the server 200 by the printer communication section 130. Further, when the printer communication control section 1115 receives the print image data 1123 from the external device by the printer communication section 130, the printer communication control section 1115 stores the print image data 1123 in the printer storage section 112. Further, when the printer communication control section 1115 receives the job data 1124, the printer communication control section 1115 stores the job data 1124 in the printer storage section 112.

### 1-4-6. Update Section

The update section 1116 updates the learned model 1127 stored in the printer storage section 112 based on the update data received by the printer communication section 130.

### 1-5. Server Configuration

Next, the functional configuration of the server 200 will be described.

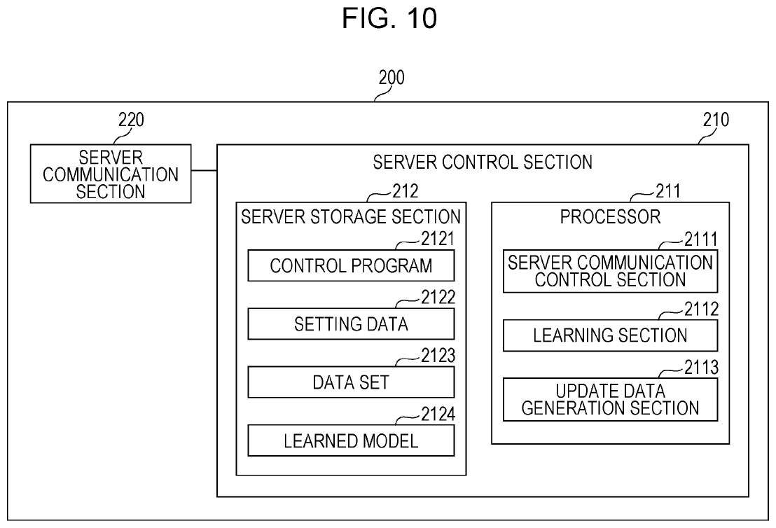

FIG. 10 is a block diagram illustrating the functional configuration of the server 200.

The server 200 includes a server control section 210.

The server control section 210 includes a processor 211 that executes programs of a CPU or an MPU, and a server storage section 212, and controls each section of the server 200. The server control section 210 executes various processing by cooperation of hardware and software so that the processor 211 reads the control program 2121 stored in the server storage section 212 to execute processing. Further, the server control section 210 functions as the server communication control section 2111, the learning section 2112, and the update data generation section 2113 by the processor 211 reading and executing the control program 2121. Details of these functional sections will be described later.

The server storage section 212 has a storage area for storing a program executed by the processor 211 and data processed by the processor 211. The server storage section 212 stores the control program 2121 executed by the processor 211, and setting data 2122 including various setting values related to the operation of the server 200. The server storage section 212 has a non-volatile storage area that stores programs or data in a non-volatile manner. Further, the server storage section 212 may include a volatile storage area and may be configured to temporarily store a program executed by the processor 211 and data to be processed.

The server 200 includes a server communication section 220.

The server communication section 220 is configured by communication hardware such as a connector according to a predetermined communication standard and an interface circuit, and communicates with the printer 100 under the control of the server control section 210.

The server control section 210 includes a server communication control section 2111, a learning section 2112, and an update data generation section 2113.

The server storage section 212 stores a control program 2121, setting data 2122, a data set 2123, and a learned model 2124.

When the server communication control section 2111 receives the data set 2123 from the printer 100 by the server communication section 220, the server communication control section 2111 stores the received data set 2123 in the server storage section 212. Also, the server communication control section 2111 transmits the learned model 2124 stored in the server storage section 212 to the printer 100 by the server communication section 220.

The learning section 2112 is artificial intelligence (AI), and is configured by software configuring the neural network NN or hardware. The learning section 2112 performs machine learning using the data set 2123, and updates the learned model 2124 stored in the server storage section 212. That is, the learning section 2112 executes learning using the data set 2123, and updates the learned model 2124 stored in the server 200 so as to reflect the learning result. The learning executed by the learning section 2112 in the present embodiment can be realized as so-called supervised learning because the data set 2123 is used. For example, in the data set 2123, the learning section 2112 learns from the data set 2123 what kind of values the three types of landing position deviation amounts are with respect to the input, by performing machine learning using the landing position information J11 as a label.

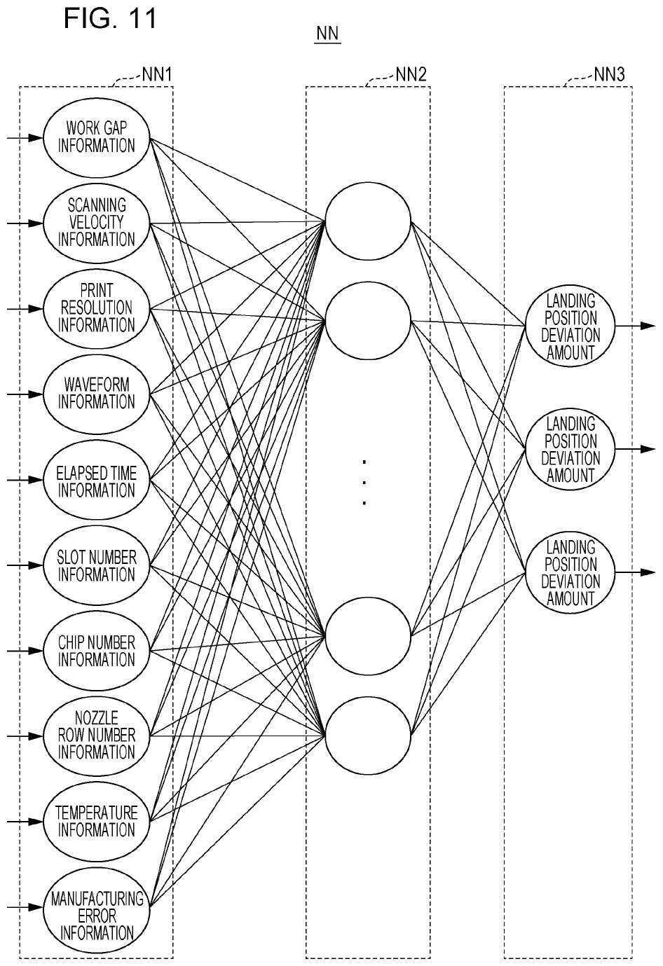

FIG. 11 is a diagram illustrating an example of the neural network NN configuring the learning section 2112.

The neural network NN illustrated in FIG. 11 has an input layer NN1, an intermediate layer NN2, and an output layer NN3 in order from the input. The neural network NN illustrated in FIG. 11 has one intermediate layer NN2, the output of the input layer NN1 is the input of the intermediate layer NN2, and the output of the intermediate layer NN2 is the input of the output layer NN3. The number of layers of the intermediate layer NN1 included in the neural network NN is not limited to one layer and may be a plurality of layers.

The number of neurons in the input layer NN1 corresponds to the number of types of information input to the learned model 1127 by the processing section 1114. The number of neurons in the intermediate layer NN2 is set appropriately for the implementation. The number of neurons in the output layer NN3 corresponds to the number of types of landing position deviation amounts output by the learned model 1127. Adjacent neurons are appropriately coupled, and a weight is set for each coupling.

The neural network NN configuring the learning section 2112 includes work gap information J1, scanning velocity information J2, print resolution information J3, waveform information J4, elapsed time information J5, slot number information J6, chip number information J7, nozzle row number information J8, temperature information J9, and manufacturing error information J10 as inputs, and three types of landing position deviation amounts are output.

Returning to the description of FIG. 10, the update data generation section 2113 generates update data for causing the printer 100 to execute the learned model 2124 that has been updated by the learning section 2112. The update data is data for updating the learned model 2124 stored in the printer 100 based on the learning result of the learning section 2112.

### 1-6. Operations of Printer and Server

Next, the operation of the printer 100 when transmitting the data set 2123 to the server 200 will be described.

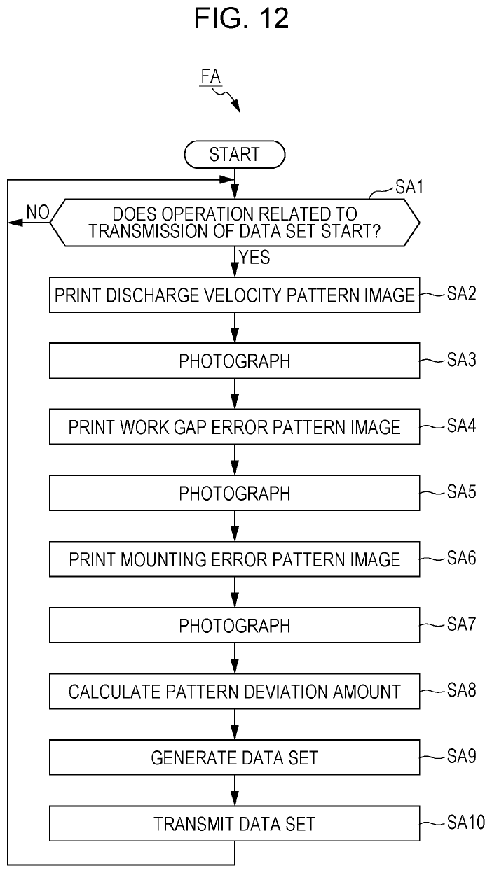

FIG. 12 is a flowchart FA illustrating an operation of the printer 100, and illustrates an operation related to the transmission of the data set 2123 to the server 200.

The data set generation section 1113 of the printer 100 determines whether to start the operation related to the transmission of the data set 2123 (step SA1).

For example, the data set generation section 1113 determines whether the period for executing the operation related to the transmission of the data set 2123 has arrived, and it is determined that the period has arrived, the data set generation section 1113 makes a positive determination in step SA1. Further, for example, when the printer 100 is powered on, the data set generation section 1113 makes a positive determination in step SA1.

When it is determined that the operation related to the transmission of the data set 2123 is started (step SA1: YES), the print control section 1112 causes the printing section 120 to print a discharge velocity pattern image PT-Vm on the printing medium W for each nozzle row NzR (step SA2).

Next, the data set generation section 1113 photographs each of discharge velocity pattern images PT-Vm with the camera 7 mounted on the carriage 82 (step SA3).

Next, the print control section 1112 causes the printing section 120 to print a work gap error pattern image PT-WG on the printing medium W for each nozzle row NzR (step SA4).

Next, the data set generation section 1113 photographs each of the work gap error pattern images PT-WG with the camera 7 mounted on the carriage 82 (step SA5).

Next, the print control section 1112 causes the printing section 120 to print a mounting error pattern image PT-TR on the printing medium W for each nozzle row NzR (step SA6).

Next, the data set generation section 1113 photographs each of the mounting error pattern images PT-TR with the camera 7 mounted on the carriage 82 (step SA7).

Note that, the order of the pattern images PT to be printed is not limited to the order of the discharge velocity pattern image PT-Vm, the work gap error pattern image PT-WG, and the mounting error pattern image PT-TR. Further, the timing of photographing with the camera 7 may be after printing all the pattern images PT.

Next, the data set generation section 1113 calculates the pattern deviation amounts from each of the photographed images obtained by the camera 7 (step SA8).

Next, the data set generation section 1113 generates the data set 2123 based on the calculated pattern deviation amount (step SA9).

Next, the printer communication control section 1115 transmits the data set 2123 generated by the data set generation section 1113 to the server 200 (step SA10).

Next, the operation of the printing system 1000 will be described.

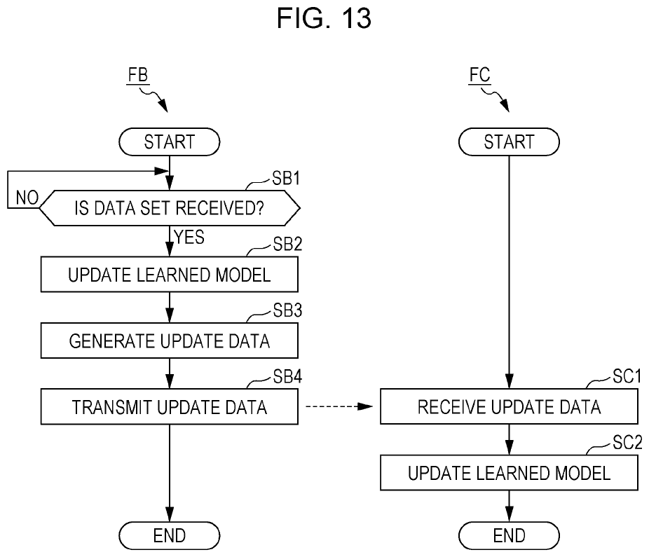

FIG. 13 is a flowchart illustrating an operation of the printing system 1000, and illustrates an operation related to updating the learned models 1127 and 2124 based on the data set 2123. In FIG. 13, a flowchart FB illustrates an operation of the server 200, and a flowchart FC illustrates an operation of the printer 100.

The server communication control section 2111 of the server 200 determines whether the data set 2123 has been received by the server communication section 220 (step SB1).

When the server communication control section 2111 determines that the server communication section 220 has received the data set 2123 (step SB1: YES), the learning section 2112 executes machine learning based on the received data set 2123 to update the learned model 2124 (step SB2).

Next, the update data generation section 2113 generates update data corresponding to the learned model 2124 updated by the learning section 2112 (step SB3).

Next, the server communication control section 2111 transmits the update data generated by the update data generation section 2113 to the printer 100 by the server communication section 220 (step SB4).

The printer communication control section 1115 of the printer 100 receives the update data by the printer communication section 130 (step SC1).

The update section 1116 updates the learned model 1127 stored in the printer storage section 112 based on the update data received by the printer communication control section 1115 by the printer communication section 130 (step SC2).

Next, the operation of the printer 100 related to printing on the printing medium W will be described.

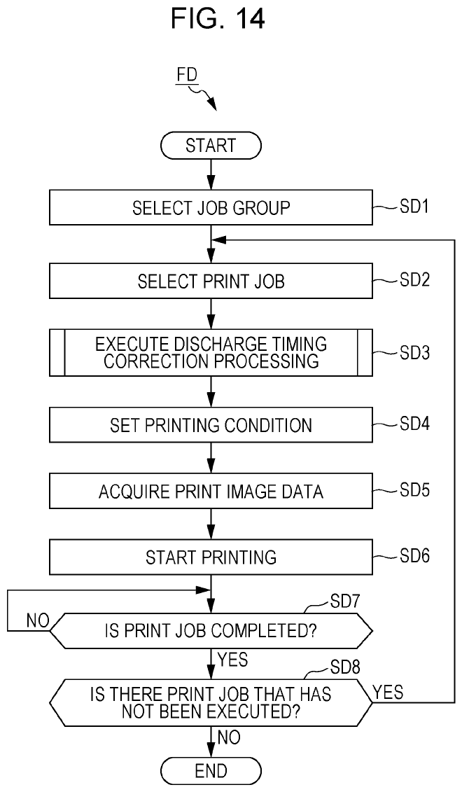

FIG. 14 is a flowchart FD illustrating the operation of the printer 100, and illustrates an operation related to printing on the printing medium W.

The print control section 1112 selects a job group 1300 to be executed from job groups 1300 included in job data 1124 according to an input operation detected by the operation section 140 (step SD1).

The job data 1124 is data for the print control section 1112 to execute printing in units of a job group 1300 including one or a plurality of print jobs IJ. Here, the job group 1300 will be described.

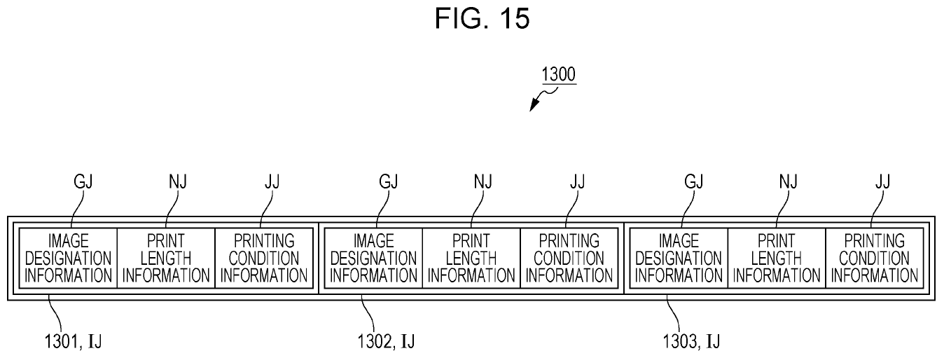

FIG. 15 is a schematic diagram illustrating a configuration of a job group 1300.

There is no limit to the number of print jobs IJ included in the job group 1300 executed by the printer 100, and the job group 1300 illustrated in FIG. 15 exemplifies a case where three print jobs 1301, 1302, and 1303 are included. The arrangement order of the print jobs 1301, 1302, and 1303 in the job group 1300 indicates the order in which the print control section 1112 executes printing. Therefore, the print jobs 1301, 1302, and 1303 are executed by the print control section 1112 in the order of the arrangement in the job group 1300.

The print job 1301 includes image designation information GJ, print length information NJ, and printing condition information JJ. The image designation information GJ is information for designating an image to be printed on the printing medium W, and designates any of the print image data 1123 stored in the printer storage section 112.

The print length information NJ is information for designating a print length that is a length for printing the image designated by the image designationi information GJ. The print length designates a size of the printing medium W on which the image of the print job 131 is printed in the transport direction H in units of meters, for example. When the print length is larger than the image size of the print image data 1123, the print control section 1112 repeatedly prints the image of the print image data 1123 on the printing medium W. Therefore, the print image data 1123 may be data of an image having a size smaller than the print length. Further, the print image data 1123 may be data of an image having a size smaller than that of the printing medium W in the intersecting direction K, that is, an image having a size smaller than the width of the printing medium W. In this case, the print control section 1112 repeatedly prints the image of the print image data 1123 even in the width direction of the printing medium W.

The printing condition information JJ is information indicating a printing condition when the print head unit 81 prints an image. For example, the printing condition indicated by the printing condition information JJ includes the work gap WG, the scanning velocity Vcr of the carriage 82, the print resolution, the ink discharge waveform, and the like. Further, the printing condition indicated by the printing condition information JJ may include the nozzle row NzR used for printing, the head row HR used for printing, the print density, the information designating the ink discharge amount per unit area, and the like.

The print jobs 1301, 1302, and 1303 included in the job group 1300 include image designation information GJ, print length information NJ, and printing condition information JJ, respectively. Therefore, the print control section 1112 can print different images in the print jobs 1301, 1302, and 1303 included in the job group 1300 with different print lengths and printing conditions.

The print control section 1112 continuously executes the print jobs 1301, 1302, and 1303 included in the job group 1300. Therefore, different images designated by each of the print jobs 1301, 1302, and 1303 are continuously printed on the long printing medium W.

The job data 1124 may include data of a plurality of job groups 1300.

The print control section 1112 refers to the job data 1124 and acquires the data of the job group 1300 designated by the operation of the operation section 140. In a case of FIG. 15, the print control section 1112 prints the print jobs 1301, 1302, and 1303 included in the designated job group 1300 in the order in which the print jobs are included in the job group 1300.

Returning to the description of FIG. 14, the print control section 1112 selects one print job IJ from the print jobs IJ included in the job group 1300 selected in step SD1 according to the execution order of the print jobs IJ (step SD2).

Next, the processing section 1114 acquires the printing condition information JJ indicating the printing condition of the selected print job IJ, and executes discharge timing correction processing based on the acquired printing condition information JJ (step SD3).

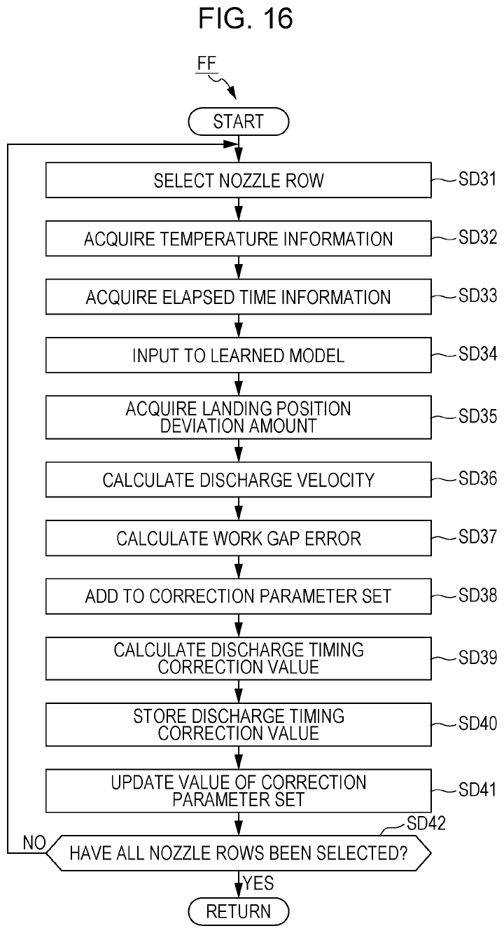

FIG. 16 is a flowchart FE illustrating an operation of the printer in the discharge timing correction processing.

The processing section 1114 selects a nozzle row NzR for which a discharge timing correction value δtotal is to be obtained (step SD31).

Next, the processing section 1114 acquires the temperature information J9 indicating the detected temperature of the print head 811 from the temperature sensor 813 provided in the print head 811 having the selected nozzle row NzR (step SD32).

Next, the processing section 1114 acquires the elapsed time information J5 (step SD33).

Next, the processing section 1114 inputs the work gap information J1, the scanning velocity information J2, the print resolution information J3, and the waveform information J4 included in the printing condition information JJ acquired in step SD3, the nozzle row number information J8 of the nozzle row NzR selected in step SD31, the chip number information J7 of the chip 812 to which the nozzle row NzR selected in step SD31 belongs, the slot number information J6 of the reservoir that supplies the ink IK to the nozzle row NzR selected in step SD31, the temperature information J9 acquired in step SD32, the elapsed time information J5 acquired in step SD33, and the manufacturing error information J10 of the chip 812 to which the nozzle row NzR selected in step SD31 belongs, to the learned model 1127 (step SD34).

Next, the processing section 1114 acquires three types of landing position deviation amounts from the learned model 1127 (step SD35).

Next, the processing section 1114 calculates the discharge velocity Vm based on the landing position deviation amount caused by the discharge velocity Vm acquired in step SD35 and the following Equation (6) (step SD36).

$$Vm = \frac{Vcr \times WGprint 1 - Vcr \times WGprint 2}{Diff - Vm} \qquad ( 6 )$$

In step SD36, the processing section 1114 substitutes the landing position deviation amount caused by the acquired discharge velocity Vm into “Diff-Vm” of Equation (6). Further, in step SD36, the processing section 1114 substitutes the scanning velocity Vcr indicated by the scanning velocity information J2 included in the printing condition acquired in step SD3 into “Vcr” in Equation (6). In addition, the processing section 1114 substitutes the set work gap WGprint indicated by the work gap information J1 included in the printing condition acquired in step SD3 into “WGprint1” in Equation (6). Further, the processing section 1114 substitutes the work gap WG obtained by subtracting a predetermined value subtracted when printing the second sub-pattern image PT-Vm2 from the set work gap WGprint substituted in “WGprint1” of Equation (6) into ‘WGprint2’ of Equation (6).

Next, the processing section 1114 calculates the work gap error WGerr based on the landing position deviation amount caused by the work gap error WGerr acquired in step SD34 and the following Equation (7) (step SD37).

$$errWG = \frac{( Diff - WG ) \times Vm}{2 \times Vcr} - WGprint \qquad ( 7 )$$

In step SD37, the processing section 1114 substitutes the landing position deviation amount caused by the acquired work gap error WGerr into “Diff-WG” of Equation (7). Further, the processing section 1114 substitutes the discharge velocity Vm calculated in Equation (6) into “Vm” of Equation (7). Further, in step SD37, the processing section 1114 substitutes the scanning velocity Vcr indicated by the scanning velocity information J2 included in the printing condition acquired in step SD3 into “Vcr” in Equation (7). In addition, the processing section 1114 substitutes the set work gap WGprint indicated by the work gap information J1 included in the printing condition acquired in step SD3 into “WGprint” in Equation (7).

The processing section 1114 adds the landing position deviation amount caused by the discharge velocity Vm calculated in step SD36, the work gap error WGerr calculated in step SD37, and the mounting error TRerr output by the learned model 1127 to the corresponding values of the correction parameter set 1125 (step SD38). Note that, for the landing position deviation amount caused by the mounting error TRerr output by the learned model 1127, the processing section 1114 directly adds it as the mounting error TRerr to the corresponding value of the correction parameter set 1125.

In step SD38, the processing section 1114 adds the landing position deviation amount caused by the discharge velocity Vm, the work gap error WGerr, and the mounting error TRerr output by the learned model 1127 to the value for the nozzle row NzR selected in step SD31.

Next, the processing section 1114 appropriately substitutes the discharge velocity Vm, the work gap error WGerr, and the mounting error TRerr obtained in step SD38 into Equations 1 to 5 to calculate the discharge timing correction value δtotal (step SD39). In step SD39, a tilt error θ of the correction parameter set is used as the tilt error θ of the print head 811.

Next, the processing section 1114 stores the calculated discharge timing correction value δtotal in the printer storage section 112 in association with the nozzle number of the nozzle row NzR selected in step SD31 (step SD40).

Next, the processing section 1114 updates the value of the correction parameter set 1125 so as to include the values of the discharge velocity Vm, the work gap error WGerr, and the mounting error TRerr obtained in the calculation of step SD38 (step SD41). The value to be updated in step SD41 is the value for the nozzle row NzR selected in step SD31.

Next, the processing section 1114 determines whether all the nozzle rows NzR included in all the print head units 81 have been selected in step SD31 (step SD42).

When it is determined that all the nozzle rows NzR have not been selected (step SD42: NO), the processing section 1114 returns the processing to step SD31 and selects one unselected nozzle row NzR.

On the other hand, when the processing section 1114 determines that all of the nozzle rows NzR have been selected (step SD42: YES), the processing section 1114 ends the discharge timing correction processing and proceeds to the processing of step SD4.

Returning to the description of FIG. 14, when the discharge timing correction processing is executed, the print control section 1112 sets the printing condition indicated by the printing condition information JJ acquired in step SD3 (step SD4).

Subsequently, the print control section 1112 acquires the print image data 1123 designated by the image designation information GJ from the printer storage section 112 (step SD5).

Next, the print control section 1112 controls the printing section 120 to start printing on the printing medium W based on the discharge timing correction value δtotal acquired for each nozzle row NzR in the discharge timing correction processing and the set printing condition (step SD6).

In the present embodiment, the unit of the discharge timing correction value δtotal is a distance. The print control section 1112 calculates, for example, for each nozzle row NzR, a correction value of the time obtained by dividing the discharge timing correction value δtotal by the scanning velocity Vcr, and corrects the discharge timing for each nozzle row NzR.

Next, the print control section 1112 determines whether the print job IJ is completed (step SD7).

When the printing of the print job IJ is not completed (step SD7: NO), the print control section 1112 executes the determination of step SD7 again.

On the other hand, when it is determined that the print job IJ is completed (step SD7: YES), the print control section 1112 determines whether there is a print job IJ that has not been executed in the job group 1300 selected in step SD1 (step SD8). When there is a print job IJ that has not been executed (step SD8: YES), the printer control section 110 returns to step SD2. When there is no print job IJ that has not been executed (step SD8: NO), the printer control section 110 ends the processing.

In this way, the processing section 1114 inputs various information to the learned model 1127 and outputs the landing position deviation amount caused by the discharge velocity Vm, the work gap error WGerr, and the mounting error TRerr. As a result, the processing section 1114 can obtain the landing position deviation amount caused by the discharge velocity Vm, the work gap error WGerr, and the mounting error TRerr that cannot be completely corrected by the correction parameter set 1125. The landing position deviation that cannot be completely corrected by the correction parameter set 1125 is caused by a usage environment of the printer 100, a usage status of the printer 100, an individual difference of the printer 100, and the like. The work gap WG, the scanning velocity Vcr, the print resolution, the ink discharge waveform, and the elapsed time may differ depending on the change in the usage status of the printer 100. Further, the temperature of the print head 811 may differ depending on the usage environment of the printer 100. Further, the mounting error TRerr and the manufacturing error may differ depending on the printer 100. The landing position deviation of the ink IK occurs due to these factors. Therefore, the processing section 1114 can obtain the landing position deviation amount caused by these factors, from the learned model 1127. Then, the printer 100 corrects the landing position deviation of the ink IK with high accuracy by correcting the discharge timing by using the landing position deviation amount without depending on the usage environment of the printer 100, the usage status of the printer 100, the individual difference of the printer 100, and the like, so that it is possible to generate a high-quality printed product.

Further, as described above, the correction parameter set 1125 is updated. Therefore, the printer 100 can maintain accurate correction of the landing position deviation of the ink IK without depending on the usage environment of the printer 100, the usage status of the printer 100, the individual difference of the printer 100, and the like, and can prevent the quality of the printed product from being deteriorated.

As described above, the printer 100 includes the printer storage section 112 that stores the learned model 1127 that has been trained by machine learning based on the data set 2123 in which the work gap information J1 indicating the work gap WG and the landing position information J11 related to the landing position deviation of the ink IK discharged from the print head 811 are associated. Further, the printer 100 includes a processing section 1114 that outputs the landing position deviation amount for correcting the landing position deviation from the learned model 1127 by acquiring a printing condition and inputting the work gap information J1 included in the acquired printing condition to the learned model 1127 stored in the printer storage section 112.

In the control method of the printer 100, the learned model 1127 that has been trained by machine learning based on the data set 2123 in which the work gap information J1 and the landing position information J11 related to the landing position deviation of the ink IK discharged from the print head 811 are associated is stored. In addition, in the control method of the printer 100, the printing condition is acquired, and the work gap information J1 included in the acquired printing condition is input to the stored learned model 1127, and the landing position deviation amount is output from the learned model 1127. The control method of the printer 100 corresponds to an example of the control method of the information processing apparatus.

The control program 1121 causes the control device 110A to store the learned model 1127 that has been trained by machine learning based on the data set 2123 in which the work gap information J1 and the landing position information J11 are associated, acquire the printing condition, input the work gap information J1 included in the acquired printing condition to the stored learned model 1127, and output the landing position deviation amount from the learned model 1127.

In this way, by using the learned model 1127 that has been trained by machine learning based on the data set 2123 in which the work gap information J1 and the landing position information J11 are associated, it is possible to obtain an accurate landing position deviation amount corresponding to the work gap WG at the time of printing. Since the landing position deviation amount is a correction value for correcting the landing position deviation of the ink IK, the printer 100 can accurately correct the landing position deviation of the ink IK by using the obtained landing position deviation amount.

The printer storage section 112 stores the learned model 1127 that has been trained by machine learning based on the data set 2123 in which the work gap information J1, the landing position information J11, and the scanning velocity information J2 are associated. The processing section 1114 acquires the scanning velocity information J2 included in the printing condition, inputs the acquired scanning velocity information J2 into the learned model 1127, and causes the learned model 1127 to output the landing position deviation amount.

In this way, by using the learned model 1127 that has been trained by machine learning based on the data set 2123 in which the work gap information J1, the scanning velocity information J2, and the landing position information J11 are associated, it is possible to obtain an accurate landing position deviation amount corresponding to the scanning velocity Vcr at the time of printing, in addition to the work gap WG at the time of printing. Therefore, the printer 100 can more accurately correct the landing position deviation of the ink IK by using the obtained landing position deviation amount.

The printer storage section 112 stores the learned model 1127 that has been trained by machine learning based on the data set 2123 in which any one of the work gap information J1, the landing position information J11, the temperature information J9 indicating the temperature of the print head 811, and the waveform information J4 is associated. The processing section 1114 acquires at least one of the temperature information J9 and the waveform information J4 included in the printing condition, further inputs at least one of the acquired temperature information J9 and waveform information J4 into the learned model 1127, and causes the learned model 1127 to output the landing position deviation amount.

In this way, by further using the learned model 1127 which has been trained by machine learning based on the data set 2123 in which the temperature information J9 and the waveform information J4 are associated, it is possible to further obtain an accurate landing position deviation amount corresponding to the discharge velocity Vm or the size of one dot. Therefore, the printer 100 can more accurately correct the landing position deviation of the ink IK by using the obtained landing position deviation amount.

The landing position information J11 is information related to the work gap error WGerr and the mounting error TRerr of the print head 811. The landing position deviation amount includes a value for correcting a landing position deviation caused by any one of the work gap error WGerr, the temperature of the print head 811, and the mounting error TRerr of the print head 811.

According to the configuration, it is possible to obtain an accurate value for the landing position deviation amount caused by any of the work gap error WGerr, the temperature of the print head 811, and the mounting error TRerr.

The print head 811 has a plurality of nozzle rows NzR. The printer storage section 112 further stores a learned model 1127 that has been trained by machine learning based on the data set 2123 in which the nozzle row number information J8 is associated for each nozzle row NzR. The processing section 1114 acquires the nozzle row number information J8, inputs the acquired nozzle row number information J8 into the learned model 1127, and causes the learned model 1127 to output the landing position deviation amount.

According to the configuration, by using the learned model 1127 that has been trained by machine learning based on the data set 2123 further associated with the nozzle row number information J8, it is possible to obtain an accurate landing position deviation amount for each nozzle row NzR. Therefore, the printer 100 can accurately correct the landing position deviation of the ink IK for each nozzle row NzR.

The printer 100 includes a print control section 1112 that causes the printing section 120 to print at a discharge timing based on the landing position deviation amount.

According to the configuration, since the printing section 120 prints at the discharge timing based on the accurate landing position deviation amount, the printing can be performed while accurately correcting the landing position deviation of the ink IK. Therefore, the printer 100 can generate high-quality printed products.

### 2. Second Embodiment

Next, a second embodiment will be described.

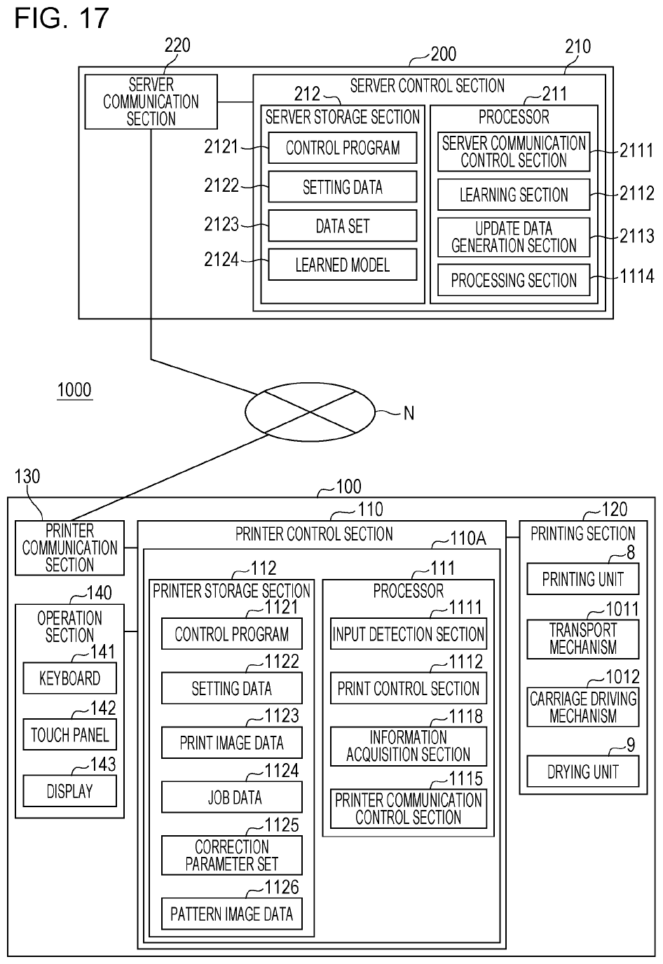

FIG. 17 is a diagram illustrating a configuration of the printing system 1000 according to the second embodiment.

In FIG. 17, when the configuration of each section of the printer 100 and the server 200 of the second embodiment is the same as the configuration of each section of the first embodiment, the same symbols are given and detailed description thereof is omitted.

In the second embodiment, the server 200 corresponds to an example of an information processing apparatus, a learning apparatus, and a computer. Further, in the second embodiment, the server storage section 212 corresponds to an example of the storage section. Further, in the second embodiment, the control program 2121 corresponds to an example of the program.

In the second embodiment, the server control section 210 includes, as functional blocks, the data set generation section 1113 and the processing section 1114 of the first embodiment.

In the second embodiment, the printer control section 110 does not include, as functional blocks, the data set generation section 1113 and the processing section 1114, but includes an information acquisition section 1118. Further, the printer storage section 112 does not store the learned model 1127.

In the second embodiment, the information acquisition section 1118 acquires photographed images of the three types of pattern images PT described in the first embodiment from the camera 7. Further, the information acquisition section 1118 also acquires various information associated with the landing position information J11. Then, the printer communication control section 1115 transmits various information associated with the photographed image and the landing position information J11 acquired by the information acquisition section 1118 to the server 200.

When the printer communication control section 1115 transmits the photographed image of the pattern image PT and various information associated with the landing position information J11, the server communication control section 2111 of the server 200 receives these. The data set generation section 1113 of the server 200 generates the data set 2123 as in the first embodiment, based on the photographed image of the pattern image PT acquired by the server communication control section 2111 and various information associated with the landing position information J11. Then, the learning section 2112 updates the learned model 2124 based on the data set 2123 generated by the data set generation section 1113.

In the second embodiment, when the printer 100 prints, the information acquisition section 1118 acquires, for the nozzle row NzR for obtaining the discharge timing correction value &total, work gap information J1, scanning velocity information J2, print resolution information J3, and waveform information J4 included in the printing condition information JJ, nozzle row number information J8 of the target nozzle row NzR, chip number information J7 of the chip 812 to which the target nozzle row NzR belongs, slot number information J6 of the reservoir that supplies the ink IK to the target nozzle row NzR, temperature information J9 indicating the temperature of the print head 811 to which the target nozzle row NzR belongs, elapsed time information J5, and manufacturing error information J10 of the chip 812 to which the target nozzle row NzR belongs. Then, the printer communication control section 1115 transmits these pieces of information to the server 200. Then, the processing section 1114 of the server 200 inputs the received information to the learned model 2124 and outputs the above-described three types of landing position deviation amounts. Next, the server communication control section 2111 transmits information indicating the three types of landing position deviation amounts output by the processing section 1114, to the printer 100. When the printer 100 receives the information indicating the three types of landing position deviation amounts for all the nozzle rows NzR, the printer 100 calculates the discharge timing correction value &total for all the nozzle rows NzR. Then, the printer 100 prints based on the calculated discharge timing correction value δtotal.

The configuration of the second embodiment also has the same effect as that of the first embodiment.

Further, the server 200 of the second embodiment includes a learning section 2112 that acquires the data set 2123 and updates the learned model 2124 stored in the server storage section 212 based on the acquired data set 2123.

In this way, since the learned model 2124 is updated by the additional learning of the data set 2123, a more accurate landing position deviation amount can be obtained by using the updated learned model 2124, and the landing position deviation of the ink IK can be more accurately corrected.

The learning section 2112 acquires the data set 2123 in which the landing position information J11 indicating the landing position deviation amount calculated from the photographed image of the pattern image PT printed by the print head 811 and the work gap information J1 are associated.

In this way, machine learning can be performed based on the data set 2123 including the landing position information J11 indicating the landing position deviation amount obtained from the pattern image PT actually printed by the print head 811. Therefore, the processing section 1114 can more accurately obtain the landing position deviation amount that may be generated in actual printing from the learned model 2124. Therefore, the printer 100 can more accurately correct the landing position deviation of the ink IK.

### 3. Third Embodiment

Next, a third embodiment will be described.

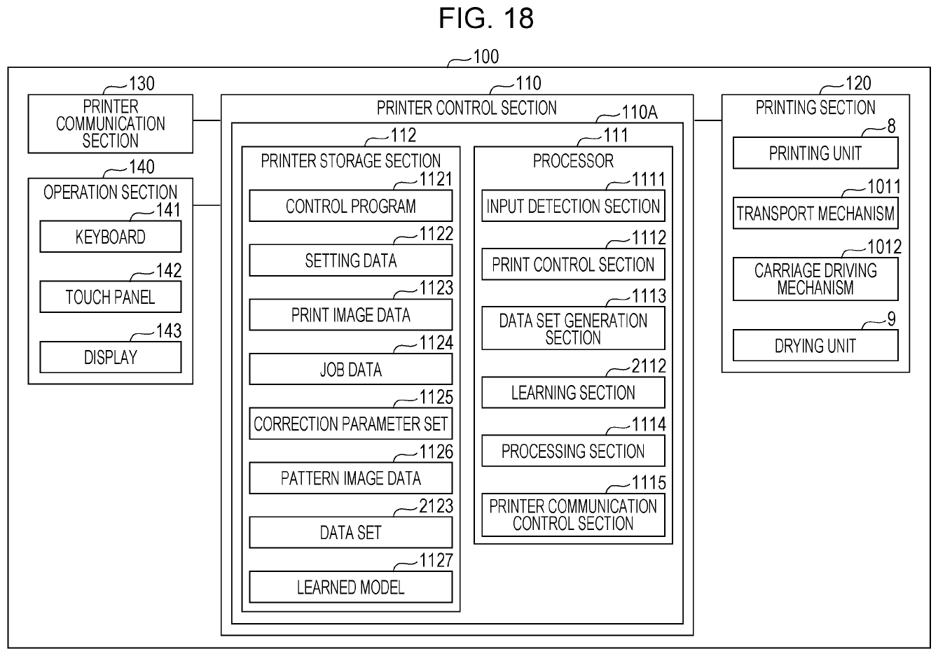

FIG. 18 is a diagram illustrating a configuration of a printer 100 according to a third embodiment.

In FIG. 18, when the configuration of each section of the printer 100 according to the third embodiment is the same as those of the configurations of the first and second embodiments, the same symbols are given and detailed description thereof is omitted.

In the second embodiment, the printer 100 corresponds to an example of an information processing apparatus, the control device 110A included in the printer control section 110 corresponds to an example of a learning apparatus and a computer, and the printer storage section 112 corresponds to an example of a storage section, and the control program 1121 corresponds to an example of a program.

In the third embodiment, the printer 100 performs additional learning. In the printer control section 110 of the third embodiment, the printer control section 110 functions as the learning section 2112, as is clear from comparison with the printers of the first and second embodiments.

In the third embodiment, the learning section 2112 of the printer control section 110 updates the learned model 1127 based on the data set 2123 generated by the data set generation section 1113.

The configuration of the third embodiment also has the same effects as those of the first and second embodiments.

### 4. Other Embodiments

The above-described embodiments show one specific example to which the present disclosure is applied, and the present disclosure is not limited to this.

In the present embodiment, the pattern deviation amount is calculated as the landing position deviation amount caused by the discharge velocity Vm, the work gap error WGerr, and the mounting error TRerr, but the landing position deviation amount included in the data set 2123 is not limited to the pattern deviation amount. Any physical quantity corresponding to the landing position deviation amount may be used. Further, the method of calculating the pattern deviation amount is not limited to the above method.

For example, in each of the above-described embodiments, the printer 100 that transports the printing medium W wound in a roll shape and prints an image has been described as an example, but the present disclosure is not limited to this. For example, the present disclosure can be applied to a printer that performs printing by fixing and holding a printing medium W such as a cloth to be printed and moving the print head 811 relative to the printing medium W. For example, the present disclosure may be applied to a so-called garment printer in which clothing or sewing cloth is fixed as the printing medium W, and the ink IK is discharged onto the printing medium W for printing. Further, the present disclosure may be applied to a printer that prints on not only a cloth but also knit fabric, paper, synthetic resin sheets, and the like.

Further, the application target of the present disclosure is not limited to an apparatus used alone as a printer, and the present disclosure may be applied to an apparatus having a function other than printing, such as a multifunction peripheral having a copy function and a scan function and a POS terminal device.

Further, the printer 100 may be an apparatus that uses the ink IK that is cured by irradiation of ultraviolet rays. In this case, the printer 100 may be provided with an ultraviolet irradiation device instead of the drying unit 9. Further, the printer 100 may include a cleaning device that cleans the printing medium W dried by the drying unit 9, and other detailed configurations of the printer 100 can be optionally changed.

Further, each functional section of the printer control section 110 can be configured as the control program 1121 executed by the processor 111 as described above, or can also be realized by a hardware circuit in which the control program 1121 is incorporated. The printer 100 may receive the control program 1121 from the server 200 or the like via a transmission medium. The same applies to each functional section of the server control section 210.

Further, the functions of the printer control section 110 and the server control section 210 may be realized by a plurality of processors or semiconductor chips.

Further, for example, the operation step unit illustrated in FIGS. 12, 13, 14, and 16 is divided according to the main processing content in order to facilitate the understanding of the operations of the printer 100 and the server 200, and the present disclosure is not limited by the division method or name of the processing unit. It may be divided into a larger number of step units according to the processing content. Further, one step unit may be divided so as to include more processing. Further, the order of the steps may be appropriately changed within a range that does not interfere with the gist of the present disclosure.

Further, the learning section 2112 can be configured as the control programs 1121 and 2121 as described above, or may be realized by a hardware circuit in which the control programs 1121 and 2121 are incorporated.

What is claimed is:

1. An information processing apparatus comprising:
a storage section that stores a learned model that was trained by machine learning based on a data set in which work gap information indicating a work gap which is a distance between a printing medium and a nozzle surface of a print head, and landing position information related to a deviation of a landing position of ink discharged from the print head are associated; and
a processing section that acquires a printing condition, and inputs the work gap information included in the acquired printing condition to the learned model stored in the storage section to cause the learned model to output a correction value for correcting the deviation.

2. The information processing apparatus according to claim 1, wherein
the storage section stores the learned model that was trained by machine learning based on the data set in which the work gap information, the landing position information, and scanning velocity information indicating a scanning velocity of a carriage on which the print head is mounted are associated, and
the processing section acquires the scanning velocity information included in the printing condition, and further inputs the acquired scanning velocity information to the learned model to cause the learned model to output the correction value.

3. The information processing apparatus according to claim 2, wherein
the storage section stores the learned model that was trained by machine learning based on the data set in which the work gap information, the landing position information, at least one of temperature information indicating a temperature of the print head and waveform information indicating a waveform of a signal input to the print head for discharging ink are associated, and
the processing section acquires at least one of the temperature information and the waveform information included in the printing condition, and further inputs at least one of the acquired temperature information and waveform information to the learned model to cause the learned model to output the correction value.

4. The information processing apparatus according to claim 3, wherein
the landing position information includes information related to a work gap error and a mounting error of the print head, and
the correction value includes a value for correcting the deviation of the landing position caused by any one of the work gap error, the temperature of the print head, and the mounting error of the print head.

5. The information processing apparatus according to claim 3, wherein
the print head has a plurality of nozzle rows,
the storage section stores the learned model that was trained by machine learning based on the data set in which the work gap information, the landing position information, and nozzle row information indicating the nozzle row are associated for each nozzle row, and
the processing section further inputs the nozzle row information to the learned model to cause the learned model to output the correction value.

6. The information processing apparatus according to claim 1, further comprising:
a print control section that causes a printing section to print at a discharge timing based on the correction value.

7. A learning apparatus comprising:
a storage section that stores a learned model that was trained by machine learning based on a data set in which work gap information indicating a work gap which is a distance between a printing medium and a nozzle surface of a print head, and landing position information related to a deviation of a landing position of ink discharged from the print head are associated; and
a processing section that acquires a printing condition, and inputs the work gap information included in the acquired printing condition to the learned model stored in the storage section to cause the learned model to output a correction value for correcting the deviation.

8. The learning apparatus according to claim 7, further comprising:
a learning section that acquires the data set and updates the learned model stored in the storage section based on the acquired data set.

9. The learning apparatus according to claim 8, wherein
the learning section acquires the data set in which the landing position information indicating a deviation amount of an ink landing position calculated from a photographed image of a pattern image printed by the print head and the work gap information are associated.

10. A control method of an information processing apparatus, the method comprising:
storing a learned model that was trained by machine learning based on a data set in which work gap information indicating a work gap which is a distance between a printing medium and a nozzle surface of a print head, and landing position information related to a deviation of a landing position of ink discharged from the print head are associated;
acquiring a printing condition; and
inputting the work gap information included in the acquired printing condition to the stored learned model to cause the learned model to output a correction value for correcting the deviation.
